(19) United States
(12) Patent Application Publication
(10) Pub. No.: US 2024/0077810 A1
(43) Pub. Date: Mar. 7, 2024

(54) DEVELOPER AND IMAGE FORMING APPARATUS

(71) Applicant: KYOCERA Document Solutions Inc., Osaka (JP)

(72) Inventors: Tamotsu SHIMIZU, Osaka-shi (JP); Kohei TERASAKI, Osaka-shi (JP); Akira MATAYOSHI, Osaka-shi (JP); Yuji TOYOTA, Osaka-shi (JP)

(73) Assignee: KYOCERA Document Solutions Inc., Osaka (JP)

(21) Appl. No.: 18/458,713

(22) Filed: Aug. 30, 2023

(30) Foreign Application Priority Data
Aug. 31, 2022 (JP) 2022-138124

(51) Int. Cl. G03G 9/087; G03G 9/10; G03G 15/08

(52) U.S. Cl. CPC G03G 9/08773; G03G 9/10; G03G 15/0865

(57) ABSTRACT

A developer includes a toner containing toner particles and a carrier containing carrier particles. The toner particles each include a toner mother particle and external additive particles attached to a surface of the toner mother particle. The external additive particles include first silica particles and spacer particles. The first silica particles have a number average primary particle diameter of at least 10 nm and no greater than 30 nm. The spacer particles have a number average primary particle diameter of at least 32 nm and no greater than 145 nm. The spacer particles in the toner particles have a coverage ratio of at least 2.0% by area and no greater than 40.0% by area. The carrier particles each include a carrier mother particle and strontium titanate particles attached to a surface of the carrier mother particle.

### INCORPORATION BY REFERENCE

The present application claims priority under 35 U.S.C. § 119 to Japanese Patent Application No. 2022-138124, filed on Aug. 31, 2022. The contents of this application are incorporated herein by reference in their entirety.

### BACKGROUND

The present disclosure relates to a developer and an image forming apparatus. Image forming apparatuses that form images with a toner are required to form images with desired density and less fogging. Some electrophotographic developer contains a toner and a carrier, for example, in order to inhibit toner attachment to a non-image area of paper. The carrier includes carrier cores each covered with a resin layer. In a process prior to mixing with the toner, at least one additive for use in the toner is added to and mixed with the carrier in advance.

### SUMMARY

A developer according to an aspect of the present disclosure includes a toner containing toner particles and a carrier containing carrier particles. The toner particles each include a toner mother particle and external additive particles attached to a surface of the toner mother particle. The external additive particles include first silica particles and spacer particles. The first silica particles have a number average primary particle diameter of at least 10 nm and no greater than 30 nm. The spacer particles have a number average primary particle diameter of at least 32 nm and no greater than 145 nm. The spacer particles in the toner particles have a coverage ratio of at least 2.0% by area and no greater than 40.0% by area. The carrier particles each include a carrier mother particle and strontium titanate particles attached to a surface of the carrier mother particle. The carrier mother particles each include a carrier core and a coat layer covering a surface of the carrier core. The coat layers contain a coating resin and barium titanate particles. The coating resin includes silicone resin. The barium titanate particles have a number average primary particle diameter of at least 100 nm and no greater than 500 nm. The strontium titanate particles have a number average primary particle diameter of at least 15 nm and no greater than 85 nm. The number average primary particle diameter of the spacer particles is greater than the number average primary particle diameter of the strontium titanate particles.

An image forming apparatus according to another aspect of the present disclosure includes a developer and a development device that develops an electrostatic latent image with the developer. The developer includes an initial developer. The development device includes an accommodation section that accommodates the initial developer. The initial developer is the aforementioned developer.

### BRIEF DESCRIPTION OF THE DRAWINGS

FIG. 1 is a cross-sectional view of an example of a toner particle and an example of a carrier particle, each contained in a developer according to a first embodiment of the present disclosure.

FIG. 2 is a cross-sectional view of an example of a state in which a toner particle and a carrier particle are close to each other.

FIG. 3 is a diagram illustrating an example of an image forming apparatus according to a second embodiment of the present disclosure.

FIG. 4 is a diagram illustrating an example of a development device and its surroundings of the image forming apparatus illustrated in FIG. 3.

### DETAILED DESCRIPTION

The meaning of the terms and measurement methods that are used in the present specification are described first. A toner is a collection (e.g., a powder) of toner particles. An external additive is a collection (e.g., a powder) of external additive particles. A carrier is a collection (e.g., a powder) of carrier particles. Values indicating for example shape or property of a powder (specific examples include a powder of toner particles, a powder of external additive particles, and a powder of carrier particles) each are a number average value of values as measured with respect to a suitable number of particles selected from the powder unless otherwise stated. The “main component” of a material means a component most abundant in the material in terms of mass unless otherwise stated. In the following description, the term “-based” may be appended to the name of a chemical compound to form a generic name encompassing both the chemical compound itself and derivatives thereof. When the term “-based” is appended to the name of a chemical compound to represent the name of a polymer, the term indicates that a repeating unit of the polymer originates from the chemical compound or a derivative thereof. The term “(meth)acryl” is used as a generic term for both acryl and methacryl. One type of each component described in the present specification may be used independently, or two or more types of the component may be used in combination.

The term saturation magnetization means a value as measured using a high sensitivity vibrating sample magnetometer (e.g., “VSM-P7”, product of TOEI INDUSTRY CO., LTD.) under a condition of an external magnetic field of 3000 (unit: Oe) unless otherwise stated. The volume median diameter (D50) of a powder is a median diameter of the powder as measured using a laser diffraction/scattering type particle size distribution analyzer (e.g., “LA-950”, product of HORIBA, Ltd.) unless otherwise stated. Unless otherwise stated, the number average primary particle diameter of a powder is a number average value of equivalent circle diameters (Heywood diameters: diameters of circles having the same areas as projected areas of the primary particles) of primary particles of the powder as measured using a scanning electron microscope. The number average primary particle diameter is a number average value of equivalent circle diameters of 100 primary particles, for example. Values for softening point (Tm) are values as measured using a capillary rheometer (e.g., “CFT-500D”, product of Shimadzu Corporation) unless otherwise stated. On an S-shaped curve (vertical axis: temperature, horizontal axis: stroke) as plotted using the capillary rheometer, the softening point corresponds to the temperature corresponding to a stroke value of “(base line stroke value+maximum stroke value)/2”. Values for melting point (Mp) is a temperature at a maximum endothermic peak on an endothermic curve (vertical axis: heat flow (DSC signal), horizontal axis: temperature) as plotted using a differential scanning calorimeter (e.g., “DSC-6220”, product of Seiko Instruments Inc.) unless otherwise state. The endothermic peak appears due to melting of the crystallization site. Values for glass transition point (Tg) are values as measured in accordance with “the Japanese Industrial Standards (JIS) K7121-2012” using a differential scanning calorimeter (e.g., “DSC-6220”, product of Seiko Instruments Inc.) unless otherwise stated. The glass transition point corresponds to the temperature corresponding to a point of inflection (specifically, an intersection point of an extrapolated baseline and an extrapolated falling line) caused by glass transition on a heat absorption curve (vertical axis: heat flow (DSC signal), horizontal axis: temperature) plotted using the differential scanning calorimeter. Values for acid value and hydroxyl value are values as measured in accordance with “the Japanese Industrial Standards (JIS) K0070-1992” unless otherwise stated. Values for mass average molecular weight (Mw) are values as measured using gel permeation chromatography unless otherwise state. Values for amount of charge (unit: μC/g) are values as measured using a compact suction-type charge measuring device (e.g., MODEL 212HS″, product of TREK, INC.) in an environment at a temperature of 25° C. and a relative humidity of 50% unless otherwise stated. The meaning of the terms and the measurement methods that are used in the present specification have been explained so far.

### First Embodiment: Developer

The following describes a developer according to a first embodiment of the present disclosure. In the following, the “developer according to the first embodiment” may be also referred to below as a “developer of the present disclosure”. The developer of the present disclosure is a two-component developer.

The developer contains a toner containing toner particles and a carrier containing carrier particles. The toner particles each include a toner mother particle and an external additive particles attached to the surface of the toner mother particle. The external additive particles include first silica particles and spacer particles. The first silica particles have a number average primary particle diameter of at least 10 nm and no greater than 30 nm. The spacer particles have a number average primary particle diameter of at least 32 nm and no greater than 145 nm. The spacer particles in the toner particles have a coverage ratio of at least 2.0% by area and no greater than 40.0% by area. The carrier particles each include a carrier mother particle and strontium titanate particles attached to the surface of the toner mother particle. The carrier mother particles each include a carrier core and a coat layer covering the surface of the carrier core. The coat layers contain a coating resin and barium titanate particles. The coating resin includes silicone resin. The barium titanate particles have a number average primary particle diameter of at least 100 nm and no greater than 500 nm. The strontium titanate particles have a number average primary particle diameter of at least 15 nm and no greater than 85 nm. The number average primary particle diameter of the spacer particles is greater than the number average primary particle diameter of the strontium titanate particles.

As a result of having the above features (also referred to below as Features X), the developer of the present disclosure can form images with desired image density and less fogging. The reasons therefore may be inferred as below.

In the developer of the present disclosure, the coat layers covering the carrier mother particles of the carrier particles contain barium titanate particles. As a result of the coat layers containing the barium titanate particles, which are ferroelectric, the carrier particles can have a large electrostatic capacity. The carrier particles with a large electrostatic capacity can be frictionally charged to a desired amount of charge (amount of charge with a polarity opposite to that of the toner particles). Accordingly, the carrier particles have high charging ability with a result that charge of which amount is commensurate with the charge acceptance of the toner particles can be stably supplied to the toner particles from the carrier particles. Therefore, the developer of the present disclosure can reduce variation in amount of charge of the toner and increase charge stability of the toner.

The specific permittivity of the barium titanate particles decreases as the size of the barium titanate is excessively reduced. By contrast, the barium titanate particles easily dissociate from the coat layers as the size thereof is excessively increased. As such, the barium titanate particles in the developer of the present disclosure are set to have a number average primary particle diameter of at least 100 nm and no greater than 500 nm. Note that strength of the coat layers can be increased by the coat layers containing the barium titanate particles with high hardness. As a result, abrasion of the coat layers of the carrier particles can be inhibited to increase the life thereof.

Furthermore, known developers may cause a phenomenon in which the toner particles directly after start of use become excessively charged. In view of the foregoing, the carrier particles of the developer of the present disclosure include strontium titanate particles on the surfaces of the carrier mother particles. The strontium titanate particles are responsible for extracting excess charge from the toner particles and moderately adjusting the amount of charge of the toner particles. As such, as a result of the carrier particles including the strontium titanate particles, excessive charge to the toner particles can be inhibited. From the above, the developer of the present disclosure can further increase charge stability of the toner.

Here, the strontium titanate particles, which have high hardness and specific gravity, are easily buried in the coat layers. Burial of the strontium titanate particles in the coat layers reduces the aforementioned effect of increasing charge stability of the toner. In view of the foregoing, the toner mother particles of the developer of the present disclosure include the spacer particles on the surfaces of the toner particles. The spacer particles reduces the contact area between the toner particles and the carrier particles to inhibit the strontium titanate particles from being buried in the coat layers. Note that the spacer particles can inhibit the first silica particles from being buried in the toner mother particles.

In order for the spacer particles to perform their function, the spacer particles must be somewhat large in size. Furthermore, the spacer particles must attach to the surfaces of the toner particles in a certain amount or more. However, when the spacer particles are excessively large or when the amount of the spacer particles is excessive, the spacer particles inhibit contact between the strontium titanate particles and the toner particles (particularly, contact between the strontium titanate particles and the first silica particles). This makes it difficult for the strontium titanate particles to extract charge from the toner particles. In view of the foregoing, in the developer of the present disclosure, the number average primary particle diameter of the spacer particles is set to be at least 32 nm and no greater than 145 nm and the spacer particles are larger in diameter than the strontium titanate particles. In addition, the spacer particles in the toner particles have a coverage ratio of at least 2.0% by area and no greater than 40.0% by area. As such, as a result of the size and coverage ratio of the spacer particles in the developer of the present disclosure being adjusted as appropriate, the strontium titanate particles can be inhibited from being buried in the coat layers over a long period of time. Thus, the developer of the present disclosure can further increase charge stability of the toner.

The reasons why the developer of the present disclosure can form images with desired image density and less fogging have been described so far. Note that in terms of increasing chargeability of the toner particles, the spacer particles preferably have chargeability with the same polarity as that of the toner particles. However, the spacer particles highly charged to the same polarity as that of the toner particles in known developers may dissociate from the toner mother particles by electrostatic repulsion and easily attach to the carrier mother particles. In view of the foregoing, the strontium titanate particles function to extract excessive charge also from the spacer particles in the developer of the present disclosure. As a result, the spacer particles are inhibited from dissociating from the toner mother particles to reliably exhibit their function in the developer of the present disclosure.

The developer of the present disclosure is suitable as a developer (particularly, an initial developer) used in image forming apparatuses of so-called trickle development type described later in a second embodiment. Upon starting developing an electrostatic latent image with an initial developer in a development device, an image forming apparatus of trickle development type develops the electrostatic latent image with the developer in the development device while performing discharge of the developer in the development device and replenishment of the development device with the replenishment developer. During image formation, the development device is replenished with the carrier together with the toner and the carrier in an excess replenishment amount in the development device is discharged. This can inhibit degradation of the carrier in the development device. Furthermore, as a result of degradation of the carrier being inhibited, the number of times of replacement of the carrier in the development device can be reduced.

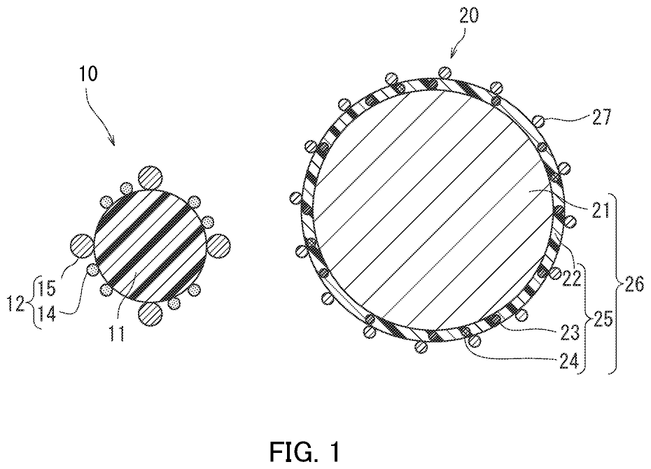

One example of each structure of the toner particles and the carrier particles is described below with reference to FIG. 1. FIG. 1 is a cross-sectional view of an example of a toner particle 10 and an example of a carrier particle 20 each contained in the developer of the present disclosure.

The toner particle 10 illustrated in FIG. 1 includes a toner mother particle 11 and external additive particles 12. The toner mother particle 11 is a non-capsule toner mother particle. The external additive particles 12 are attached to (provided on) the surface of the toner mother particle 11. The external additive particles 12 include first silica particles 14 and spacer particles 15. The external additive particles 12 may further include particles (also referred to below as additional toner external additive particles) other than the first silica particles 14 and the spacer particles 15.

The carrier particle 20 illustrated in FIG. 1 includes a carrier mother particle 26 and strontium titanate particles 27. The strontium titanate particles 27 are attached to (provided on) the surface of the carrier mother particle 26. The carrier mother particle 26 includes a carrier core 21 and a coat layer 25. The coat layer 25 covers the surface of the carrier core 21. For example, the coat layer 25 covers the entire surface of the carrier core 21. The coat layer 25 contains barium titanate particles 23 and a coating resin constituting a coating resin area 22. The coat layer 25 may further contain carbon black particles 24 as necessary.

Examples of the structures of the toner particles and the carrier particles each contained in the developer of the present disclosure have been described so far with reference to FIG. 1. However, the structures of the toner particles and the carrier particles each contained in the developer of the present disclosure are not limited particularly and may be structures different from the toner particle 10 and the carrier particle 20 each illustrated in FIG. 1. For example, the external additive particles may include aluminum oxide particles as the additional toner external additive particles. The toner mother particles may be capsule toner mother particles each including a toner core and a shell layer covering the toner core. Furthermore, it is only required that the coat layer of each carrier particle coats at least a part of the carrier core. That is, a part of the carrier core may be exposed. Furthermore, the coat layers of the carrier particles may not contain the carbon black particles. The toner and the carrier are described next further in detail.

### <Toner>

The toner contains toner particles. As described previously, the toner particles each include a toner mother particle and external additive particles.

### <<External Additive Particles of Toner Particles>>>

The external additive particles of the toner particles include first silica particles, spacer particles, and additional toner external additive particles as necessary.

### (First Silica Particles)

The first silica particles optimize fluidity and chargeability of the toner particles. The first silica particles have a number average primary particle diameter of at least 10 nm and no greater than 30 nm, and preferably at least 15 nm and no greater than 25 nm. The first silica particles may be surface treated. For example, either or both hydrophobicity and positive chargeability may be imparted to the surfaces of the first silica particles with a surface treatment agent.

The amount of the first silica particles is preferably at least 0.1 parts by mass and no greater than 10.0 parts by mass relative to 100.0 parts by mass of the toner mother particles in the toner particles, and more preferably at least 0.4 parts by mass and no greater than 3.0 parts by mass.

### (Spacer Particles)

The spacer particles have a number average primary particle diameter of at least 32 nm and no greater than 145 nm as described previously, preferably at least 32 nm and no greater than 125 nm, more preferably at least 45 nm and no greater than 100 nm, and further preferably at least 55 nm and no greater than 70 nm. The number average primary particle diameter of the spacer particles is greater than the number average primary particle diameter of the strontium titanate particles. The difference between the number average primary particle diameter of the spacer particles and the number average primary particle diameter of the strontium titanate particles is preferably at least 5 nm, and more preferably at least 20 nm.

The spacer particles in the toner particles have a coverage ratio of at least 2.0% by area and no greater than 40.0% by area as described previously, preferably at least 5.0% by area and no greater than 25.0% by area, and more preferably at least 12.0% by area and no greater than 18.0% by area. The coverage ratio of the spacer particles is mainly determined according to the amount of the spacer particles and the number average primary particle diameter of the spacer particles. Specifically, the coverage ratio of the spacer particles naturally increases as the amount of the spacer particles is increased. However, even when the amount of the spacer particles is fixed, the coverage ratio of the spacer particles decreases as the number average primary particle diameter of the spacer particles is increased. This is because the ratio of the projection area of the spacer particles to the mass of the spacer particles decreases as the number average primary particle diameter of the spacer particles is increased. Note that the coverage ratio of the spacer particles is measured by the method described in Example or a method in compliance therewith.

In terms of adjusting the coverage ratio of the spacer particles in the above range, the amount of the spacer particles is preferably at least 0.01 parts by mass and no greater than 4.0 parts by mass relative to 100.0 parts by mass of the toner mother particles in the toner particles, more preferably at least 0.09 parts by mass and no greater than 3.2 parts by mass, and further preferably at least 0.3 parts by mass and no greater than 1.2 parts by mass.

No particular limitations are placed on the spacer particles, and any particles with a number average primary particle diameter within the aforementioned range can be used among particles typically used as external additive particles of toners. Examples of the spacer particles include silica particles (in the following, silica particles used as the spacer particles may be also referred to below as “second silica particles”), resin particles, aluminum oxide particles, magnesium oxide particles, zinc oxide particles, and composite particles obtained by combining any of them. Examples of the composite particles include composite particles including resin particles and silica particles attached to the surfaces of the resin particles (silica particles included in the composite particles may be also referred to below as “third silica particles”).

The spacer particles are preferably the second silica particles, the resin particles, or the composite particles. However, images with slightly low fixability are tend to be formed with use of spacer particles including silica particles although no practical problems are involved. This is because toner particles covered with large-diameter silica particles are slightly less meltable in fixing to recording mediums. Therefore, the spacer particles are preferably the resin particles or the composite particles.

When the spacer particles include resin particles, the resin particles have a number average primary particle diameter of preferably at least 32 nm and no greater than 125 nm, and more preferably at least 45 nm and no greater than 90 nm. The resin particles may be crosslinked resin particles or non-crosslinked resin particles. Examples of the crosslinked resin particles include particles containing a polymer of a raw material monomer including a cross-linkable monomer.

In order to favorably fix the toner particles to recording mediums, the resin particles are preferably thermoplastic resin particles, and more preferably styrene-acrylic resin particles. Styrene-acrylic resin is a copolymer of at least one styrene-based monomer, at least one acrylic acid-based monomer, and an additional monomer used as needed. The additional monomer is preferably a cross-linkable monomer (e.g., divinylbenzene). The styrene-acrylic resin is preferably a copolymer of styrene and (meth)acrylic acid alkyl ester or a copolymer of styrene, (meth)acrylic acid alkyl ester, and divinylbenzene, and more preferably a copolymer of styrene and butyl (meth)acrylate or a copolymer of styrene, butyl (meth)acrylate, and divinylbenzene.

The percentage content of a repeating unit derived from styrene in all repeating units included in styrene-acrylic resin is preferably at least 1% by mol and no greater than 30% by mol, and more preferably at least 5% by mol and no greater than 25% by mol. The percentage content of a repeating unit derived from (meth)acrylic acid alkyl ester in all the repeating units included in the styrene-acrylic resin is preferably at least 10% by mol and no greater than 90% by mol, and more preferably at least 30% by mol and no greater than 85% by mol. The percentage content of a repeating unit derived from the cross-linkable monomer in all the repeating units included in the styrene-acrylic resin is preferably at least 20% by mol and no greater than 70% by mol, and more preferably at least 40% by mol and no greater than 60% by mol.

When the spacer particles include the second silica particles, the second silica particles have a number average primary particle diameter of preferably at least 32 nm and no greater than 145 nm, and more preferably at least 50 nm and no greater than 90 nm.

When the spacer particles include the composite particles, the composite particles have a number average primary particle diameter of preferably at least 40 nm and no greater than 130 nm, and more preferably at least 70 nm and no greater than 100 nm. The resin particles included in the composite particles are preferably the aforementioned styrene-acrylic resin particles. The resin particles included in the composite particles have a number average primary particle diameter of preferably at least 32 nm and no greater than 110 nm, and more preferably at least 50 nm and no greater than 90 nm. The third silica particles included in the composite particles have a number average primary particle diameter of preferably at least 10 nm and no greater than 30 nm, and more preferably at least 15 nm and no greater than 25 nm. Note that the aforementioned composite particles can be obtained by applying an adhesive component such as silicone oil to the surfaces of the resin particles and then stirring the third silica particles and the resin particles with the adhesive component applied thereto.

### (Additional Toner External Additive Particles)

Examples of the additional toner external additive particles include resin particles, aluminum oxide particles, magnesium oxide particles, and zinc oxide particles (excluding those corresponding to the spacer particles). The additional toner external additive particles are preferably aluminum oxide particles. The aluminum oxide particles are suitable as an abrasive for abrading the surfaces of photosensitive members. The aluminum oxide particles have a number average primary particle diameter of preferably at least 200 nm and no greater than 600 nm, and more preferably at least 300 nm and no greater than 500 nm.

The amount of the additional toner external additive particles is preferably at least 0.05 parts by mass and no greater than 3.0 parts by mass relative to 100.0 parts by mass of the toner mother particles, and more preferably at least 0.3 parts by mass and no greater than 1.5 parts by mass.

### <<Toner Mother Particles>>

The toner mother particles contain a binder resin, for example. The toner mother particles may further contain at least one selected from the group consisting of a colorant, a charge control agent, and a releasing agent. The binder resin, the colorant, the charge control agent, and the releasing agent are described below.

### (Binder Resin)

In order that the toner has excellent low-temperature fixability, the toner mother particles preferably contain a thermoplastic resin as the binder resin, and more preferably contain a thermoplastic resin at a percentage content of at least 85% by mass to the total of the binder resin. Examples of the thermoplastic resin include polyester resin, styrene-based resin, acrylic acid-based resin, acrylic acid ester-based resins (specific examples include acrylic acid ester polymers and methacrylic acid ester polymers), olefin-based resins (specific examples include polyethylene resin and polypropylene resin), vinyl resins (specific examples include vinyl chloride resin, polyvinyl alcohol, vinyl ether resin, and N-vinyl resin), polyamide resin, and urethane resin. Any copolymer of these resins, that is, a copolymer (specific examples include styrene-acrylic resin and styrene butadiene resin) in which any repeating unit has been introduced into any of the above resins can be used as the binder resin.

The binder resin is preferably polyester resin. The polyester resin is a polymer of one or more polyhydric alcohol monomers and one or more polybasic carboxylic acid monomers. Note that a polybasic carboxylic acid derivative (specific examples include an anhydride of polybasic carboxylic acid and a halide of polybasic carboxylic acid) may be used instead of the polybasic carboxylic acid monomer.

Examples of the polyhydric alcohol monomers include diol monomers, bisphenol monomers, and tri-or higher-hydric alcohol monomers.

Examples of the diol monomers include ethylene glycol, diethylene glycol, triethylene glycol, 1,2-propanediol, 1,3-propanediol, 1,4-butanediol, neopentyl glycol, 2-butene-1,4-diol, 1,5-pentanediol, 1,6-hexanediol, 1,4-cyclohexanedimethanol, 1,4-benzenediol, dipropylene glycol, polyethylene glycol, polypropylene glycol, and polytetramethylene glycol.

Examples of the bisphenol monomers include bisphenol A, hydrogenated bisphenol A, bisphenol A ethylene oxide adduct, and bisphenol A propylene oxide adduct.

Examples of the tri- or more-hydric alcohol monomers include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the polybasic carboxylic acid monomers include dibasic carboxylic acid monomers and tri- or higher-basic carboxylic acid monomers.

Examples of the dibasic carboxylic acid monomers include maleic acid, fumaric acid, citraconic acid, itaconic acid, glutaconic acid, phthalic acid, isophthalic acid, terephthalic acid, 5-sulfoisophthalic acid, sodium 5-sulfoisophthalate, cyclohexanedicarboxylic acid, adipic acid, sebacic acid, azelaic acid, malonic acid, succinic acid, alkyl succinic acids, and alkenyl succinic acids. Examples of the alkyl succinic acids include n-butylsuccinic acid, isobutylsuccinic acid, n-octylsuccinic acid, n-dodecylsuccinic acid, and isododecyl succinic acid. Examples of the alkenyl succinic acids include n-butenylsuccinic acid, isobutenylsuccinic acid, n-octenylsuccinic acid, n-dodecenylsuccinic acid, and isododecenylsuccinic acid.

Examples of the tri- or higher-basic carboxylic acid monomers include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and Empor trimer acid.

The polyester resin is preferably a polymer of a bisphenol monomer, a dibasic carboxylic acid monomer, and a tribasic carboxylic acid monomer. More preferably, the polyester resin is a polymer of a bisphenol A alkylene oxide adduct, dicarboxylic acid with a carbon number of at least 3 and no greater than 6, and aryl tricarboxylic acid. Further preferably, the polyester resin is a polymer of a bisphenol A ethylene oxide adduct, a bisphenol A propylene oxide adduct, fumaric acid, and trimellitic acid.

The polyester resin is preferably non-crystalline polyester resin. It is often not possible to determine a definite melting point for non-crystalline polyester resin. Therefore, polyester resin of which endothermic peak cannot be definitely identified on an endothermic curve plotted using a differential scanning calorimeter can be determined to be non-crystalline polyester resin.

The polyester resin has a softening point of preferably at least 50° C. and no greater than 200° C., and more preferably at least 80° C. and no greater than 120° C. The polyester resin has a glass transition point of preferably at least 40° C. and no greater than 100° C., and more preferably at least 40° C. and no greater than 60° C.

The polyester resin has a mass average molecular weight of preferably at least 10,000 and no greater than 50,000, and more preferably at least 20,000 and no greater than 40,000.

The polyester resin has an acid value of preferably at least 1 mgKOH/g and no greater than 30 mgKOH/g, and more preferably at least 10 mgKOH/g and no greater than 20 mgKOH/g. The polyester resin has a hydroxyl value of preferably at least 1 mgKOH/g and no greater than 50 mgKOH/g, and more preferably at least 20 mgKOH/g and no greater than 40 mgKOH/g.

### (Colorant)

Any known pigment or dye can be used as the colorant according to the color of the toner. Examples of the colorant include a black colorant, a yellow colorant, a magenta colorant, and a cyan colorant.

Examples of the black colorant include carbon black. Alternatively, the black colorant may be a colorant of which color is adjusted to a black color using a yellow colorant, a magenta colorant, and a cyan colorant.

One or more compounds selected from the group consisting of a condensed azo compound, an isoindolinone compound, an anthraquinone compound, an azo metal complex, a methine compound, and an aryl amide compound may be used as the yellow colorant. Examples of the yellow colorant include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, or 194), Naphthol Yellow S, Hansa Yellow G, and C.I. Vat Yellow.

One or more compounds selected from the group consisting of a condensed azo compound, a diketopyrrolopyrrole compound, an anthraquinone compound, a quinacridone compound, a basic dye lake compound, a naphthol compound, a benzimidazolone compound, a thioindigo compound, and a perylene compound may be used as the magenta colorant. Examples of the magenta colorant include C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221, or 254).

One or more compounds selected from the group consisting of a copper phthalocyanine compound, an anthraquinone compound, and a basic dye lake compound may be used as the cyan colorant. Examples of the cyan colorant include C.I. Pigment Blue (1, 7, 15, 15:1, 15:2, 15:3, 15:4, 60, 62, or 66), Phthalocyanine Blue, C.I. Vat Blue, and C.I. Acid Blue.

The amount of the colorant is preferably at least 1 part by mass and no greater than 20 parts by mass relative to 100 parts by mass of the binder resin.

### (Charge Control Agent)

The charge control agent is used for the purpose of obtaining a toner excellent in charge stability and charge rise characteristics, for example. The charge rise characteristic of the toner serves as an indicator as to whether the toner can be charged to a specific charge level in a short period of time. Examples of the charge control agent include a positive charge control agent and a negative charge control agent. Cationic strength (positive chargeability) of the toner can be increased through the toner mother particles containing a positive charge control agent. Anionic strength (negative chargeability) of the toner can be increased through the toner mother particles containing a negative charge control agent. Examples of the positive charge control agent include pyridine, nigrosine, and quaternary ammonium salt. Examples of the negative charge control agent include metal-containing azo dye, sulfo group-containing resin, oil-soluble dye, metal salts of naphthenic acid, metal acetylacetonate complexes, salicylic acid-based metal complexes, boron compounds, fatty acid soap, and long-chain alkyl carboxylic acid salts. However, the charge control agent need not be contained in the toner mother particles when sufficient chargeability of the toner can be ensured. The amount of the charge control agent is preferably at least 0.1 parts by mass and no greater than 10.0 parts by mass relative to 100 parts by mass of the binder resin.

### (Releasing Agent)

The releasing agent is used for the purpose of obtaining a toner excellent in hot offset resistance, for example. Examples of the releasing agent include aliphatic hydrocarbon-based waxes, oxides of aliphatic hydrocarbon-based waxes, plant-derived waxes, animal-derived waxes, mineral-derived waxes, ester waxes of which main component is fatty acid ester, and waxes in which a part or all of a fatty acid ester has been deoxidized. Examples of the aliphatic hydrocarbon-based waxes include polyethylene waxes (e.g., low molecular weight polyethylene), polypropylene waxes (e.g., low molecular weight polypropylene), polyolefin copolymers, polyolefin wax, microcrystalline wax, paraffin wax, and Fischer-Tropsch wax. Examples of the oxides of aliphatic hydrocarbon-based waxes include oxidized polyethylene wax and block copolymers of oxidized polyethylene wax. Examples of the plant-derived waxes include candelilla wax, carnauba wax, Japan wax, jojoba wax, and rice wax. Examples of the animal-derived waxes include beeswax, lanolin, and spermaceti. Examples of the mineral-derived waxes include ozokerite, ceresin, and petrolatum. Examples of the ester waxes of which main component is fatty acid ester include montanic acid ester wax and castor wax. Examples of the waxes in which a part or all of a fatty acid ester has been deoxidized include deoxidized carnauba wax. The amount of the releasing agent is preferably at least 1 part by mass and no greater than 20 parts by mass relative to 100 parts by mass of the binder resin.

Note that the toner particles may contain any known additive as necessary. The toner particles preferably have a volume median diameter of at least 4 μm and no greater than 12 μm. The volume median diameter of the toner mother particles is preferably at least 4 μm and no greater than 12 μm, and more preferably at least 5 μm and no greater than 9 μm. When the developer of the present disclosure is used as an initial developer, the toner has a percentage content of at least 1% by mass and no greater than 15% by mass in the developer of the present disclosure, and more preferably at least 3% by mass and no greater than 10% by mass. When the developer of the present disclosure is used as the replenishment developer, the toner has a percentage content of preferably at least 50% by mass and no greater than 99% by mass in the developer of the present disclosure, and more preferably at least 80% by mass and no greater than 95% by mass. The toner has been described so far.

### <Carrier>

The carrier contains carrier particles. As described previously, the carrier particles include strontium titanate particles and carrier mother particles.

### <<Strontium Titanate Particles>>

The strontium titanate particles have a number average primary particle diameter of at least 15 nm and no greater than 85 nm as described previously. In terms of forming images with desired image density and less fogging, the strontium titanate particles have a number average primary particle diameter of preferably at least 20 nm and no greater than 80 nm, more preferably at least 20 nm and no greater than 60 nm, and further preferably at least 25 nm and no greater than 40 nm.

In terms of forming images with desired image density and less fogging, the amount of the strontium titanate particles is preferably at least 0.02 parts by mass and no greater than 0.06 parts by mass relative to 100.00 parts by mass of the carrier mother particles, and more preferably at least 0.03 parts by mass and no greater than 0.05 parts by mass.

The strontium titanate particles may be doped. When the strontium titanate particles are doped, the amount of a doped element may be no greater than 1.00% by mass to the total mass of the strontium titanate particles, no greater than 0.10% by mass, or less than 0.01% by mass. However, the strontium titanate particles may not be doped. The strontium titanate particles may be constituted by non-doped strontium titanate. For example, the strontium titanate particles may be constituted by strontium titanate to which lanthanum and Group 5 Elements (e.g., niobium or tantalum) of the Periodic Table are not doped.

### <<Carrier Mother Particles>>

As described previously, the carrier mother particles each include a carrier core and a coat layer. In terms of forming images with desired image density and less fogging, the mass ratio (also referred to below as coat layer/core ratio) of the coat layers to the carrier cores is preferably at least 0.5% by mass and no greater than 5.0% by mass, and more preferably at least 1.2% by mass and no greater than 2.5% by mass.

### (Carrier Cores)

The carrier cores contain a magnetic material, for example. Examples of the magnetic material contained in the carrier cores include metal oxides. More specific examples thereof include magnetite, maghemite, and ferrite. Ferrite has high fluidity and tends to be chemically stable. Therefore, the carrier cores preferably contain ferrite in terms of forming high-quality images for a long period of term. Examples of the ferrite include barium ferrite, manganese ferrite (Mn-ferrite), Mn—Zn ferrite, Ni—Zn ferrite, Mn—Mg ferrite, Ca—Mg ferrite, Li ferrite, and Cu—Zn ferrite. The shape of the carrier cores is not particularly limited and can be irregular or spherical. The carrier cores can be commercially available. Furthermore, the carrier cores may be self-made by pulverizing and baking a magnetic material.

The carrier cores have a volume median diameter of preferably at least 15.0 μm and no greater than 65.0 μm, and more preferably at least 30.0 μm and no greater than 50.0 μm. As a result of the volume median diameter of the carrier cores being set to at least 15.0 μm, a defect (carrier development) in which the carrier particles attach to a photosensitive member is less likely to occur. As such, carrier particles attached to the photosensitive member can be inhibited from moving to a transfer belt from the photosensitive member to inhibit occurrence of image defects such as a transfer defect. Also, occurrence of poor cleaning can be inhibited because carrier development hardly occurs. As a result of the volume median diameter of the carrier cores being set to no greater than 65.0 μm by contrast, the magnetic brush of the developer of the present disclosure formed on the circumferential surface of a developer bearing member in image formation is thick, thereby achieving formation of high-quality images.

Preferably, the carrier cores have a saturation magnetization of at least 65 emu/g and no greater than 90 emu/g. When the carrier cores contain Mn-ferrite, the saturation magnetization of the carrier cores tends to decrease as the percentage content of Mn is increased. Also, when the carrier cores contain Mn—Mg ferrite, the saturation magnetization of the carrier cores tends to decrease as the percentage content of Mg is increased.

### (Coat Layers)

As described previously, the coat layers contain a coating resin, barium titanate particles, and carbon black particles as necessary.

The coating resin is described below. The coating resin includes silicone resin. As a result of the coating resin including silicone resin, the toner can be frictionally charged in a favorable manner. Preferable examples of the silicone resin include silicone resins with a methyl group and an epoxy resin-modified silicone resin. An example of the silicone resins with a methyl group is a silicone resin with a methyl group and no phenyl groups. Another example of the silicone resins with a methyl group is a silicone resin (also referred to below as methylphenyl silicone resin) with a methyl group and a phenyl group. The coat layers may contain only the silicone resin as the coating resin or further contain a resin other than the silicone resin. The silicone resin has a percentage content of preferably at least 80% by mass to the mass of the coating resin, more preferably at least 90% by mass, and particularly preferably 100% by mass. The coating resin has been described so far.

The barium titanate particles are described next. In order to form images with desired image density and less fogging, the content ratio of the barium titanate particles is preferably at least 2 parts by mass and no greater than 47 parts by mass to 100 parts by mass of the coating resin, more preferably at least 3 parts by mass and no greater than 35 parts by mass, and further preferably at least 10 parts by mass and no greater than 25 parts by mass. When the coating resin includes two or more resins, the mass of the coating resin means the total mass of the two or more resins.

As described previously, the barium titanate particles have a number average primary particle diameter of at least 100 nm and no greater than 500 nm, preferably at least 150 nm and no greater than 450 nm, and more preferably at least 250 nm and no greater than 350 nm. In terms of achieving easy and uniform dispersion in the coating resin, the barium titanate particles are preferably constituted by a hydrothermal compound. The barium titanate particles have been described so far.

The carbon black particles are described next. The carbon black particles are conductive. As such, when the coat layers contain the carbon black particles, charge can smoothly move from the carrier particles to the toner particles. As a result, the toner particles can be charged to a desired amount of charge, thereby achieving formation of images with desired image density and less fogging.

The carbon black particles have a number average primary particle diameter of preferably at least 10 nm and no greater than 80 nm, and more preferably at least 30 nm and no greater than 45 nm. The carbon black particles have a dibutyl phthalate (DBP) oil absorption of preferably at least 300 cm³/100 g and no greater than 700 cm³/100 g, and more preferably at least 400 cm³/100 g and no greater than 600 cm³/100 g. The carbon black particles have a BET specific surface area of preferably at least 1000 m²/g and no greater than 2000 m²/g, and more preferably at least 1200 m²/g and no greater than 1500 m ²/g. The amount of the carbon black particles is preferably at least 1 part by mass and no greater than 20 parts by mass relative to 100 parts by mass of the coating resin, and more preferably at least 5 parts by mass and no greater than 12 parts by mass. The carbon black particles have been described so far.

Note that the carrier particles may include additional carrier external additive particles as necessary. The additional carrier external additive particles are selected from among known external additives. Alternatively, the carrier particles may further contain any known additives. The carrier particles preferably have a volume median diameter of at least 25 μm and no greater than 100 μm. The carrier has been described so far.

In terms of formation of images with desired image density and less fogging, a distance L in the developer of the present disclosure calculated using the following equation is preferably at least −15 nm and no greater than 95 nm, more preferably at least 5 nm and no greater than 65 nm, and further preferably at least 5 nm and no greater than 25 nm.

Distance L=(number average primary particle diameter of spacer particles)−((number average primary particle diameter of strontium titanate particles)+(number average primary particle diameter of first silica particles))

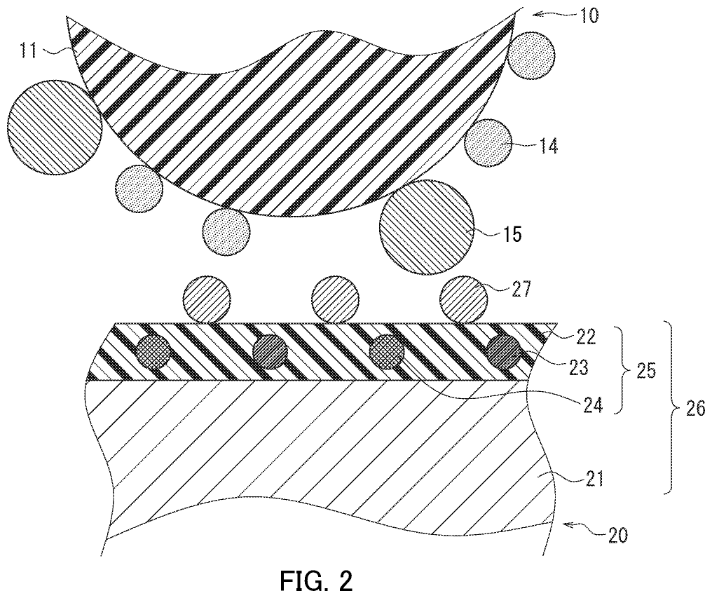

The following describes reasons why the distance L is preferably in the above range with reference to FIG. 2. FIG. 2 is a cross-sectional view of a state in which the toner particle 10 is close to the carrier particle 20 in FIG. 1. In order for the toner particles 10 to be charged normally, the first silica particles 14, which significantly contribute to chargeability of the toner particles 10, should be close to some extent to the carrier particles 20 being a charge supply source. However, when the spacer particles 15 are excessively large, the spacer particles 15 inhibit the first silica particles 14 and the carrier particles 20 from being close to each other. Therefore, the toner particles 10 can be sufficiently charged by setting the distance L to the specific value or less (no greater than 95 nm) to allow the first silica particles 14 and the carrier particles 20 to be close to each other to some extent. When the spacer particles 15 are excessively small by contrast, the first silica particles 14 and the carrier particles 20 come into contact with each other excessively to allow the first silica particles 14 to be easily buried in the toner mother particles 11 and allow the strontium titanate particles 27 to be easily buried in the coat layers 25 (e.g., the coating resin area 22). Therefore, burial of the first silica particles in the toner mother particles 11 and burial of the strontium titanate particles 27 in the coat layers 25 can be inhibited and charge stability of the toner particles 10 can be increased in the developer of the present disclosure by setting the distance L to the specific value or more (at least −15 nm). The distance L has been described so far with reference to FIG. 2.

<Developer Production Method>

The following describes an example of a method for producing the developer of the present disclosure. The method for producing the developer of the present disclosure includes a toner formation process, a carrier formation process, and a process of mixing the toner and the carrier.

(Toner formation Process)

In the toner formation process, the binder resin, the colorant, the charge control agent, and the releasing agent are mixed to yield a mixture. The resultant mixture was melt-kneaded to obtain a melt-kneaded product. The melt-kneaded product is pulverized to obtain a pulverized product. The resultant pulverized product is classified to obtain toner mother particles. The toner mother particles and external additive particles (the first silica particles, the spacer particles, and any other additional toner external additive particles) are mixed using a mixer. Through mixing, the external additive particles are attached to the surfaces of the toner mother particles, thereby obtaining a toner containing toner particles. Preferably, mixing with the external additive particles is performed under a condition where the external additive particles are not completely buried in the toner mother particles.

### (Carrier Formation Process)

The carrier formation process includes a process of forming the carrier mother particles and a process of adding the external additive to the carrier mother particles.

In the process of forming the carrier mother particles, the coat layers are formed on the surfaces of the carrier cores to obtain the carrier mother particles. For example, a coating liquid containing the coating resin, the barium titanate particles, and any carbon black particles is sprayed toward the carrier cores in a fluid bed. Next, the carrier cores toward which the coating liquid has been sprayed are heated at a first specific temperature (also referred to below as specific dry temperature) to dry the coating liquid attached to the surfaces of the carrier cores, thereby obtaining a dried product. Next, the dried product is heated at a second specific temperature (also referred to below as specific baking temperature) using an electric furnace to harden the coating resin contained in the coating liquid on the surfaces of the carrier cores. In the manner described above, the coat layers are formed on the surfaces of the carrier cores. The specific dry temperature is preferably at least 70° C. and no greater than 85° C. The specific baking temperature is preferably at least 200° C. and no greater than 300° C.

In the process of adding the external additive to the carrier mother particles, the carrier mother particles and the strontium titanate particles are mixed using a mixer. Through mixing, the strontium titanate particles are attached to the surfaces of the carrier mother particles to obtain a carrier containing carrier particles. Mixing with the strontium titanate particles is preferably performed under a condition where the strontium titanate particles are not completely buried in the carrier mother particles.

### (Process of Mixing Toner and Carrier)

In the process of mixing the toner and the carrier, the toner and the carrier are mixed using a mixer to obtain the developer of the present disclosure.

### Second Embodiment: Image Forming Apparatus

The following describes an image forming apparatus according to a second embodiment. The image forming apparatus according to the second embodiment includes at least a developer and a development device. The development device develops an electrostatic latent image with the developer. The developer includes an initial developer. The development device includes an accommodation section that accommodates the initial developer. The initial developer is the developer described in the first embodiment. As a result of including the developer according to the first embodiment as the initial developer, the image forming apparatus according to the second embodiment can form images with desired image density and less fogging for the reasons described in the first embodiment.

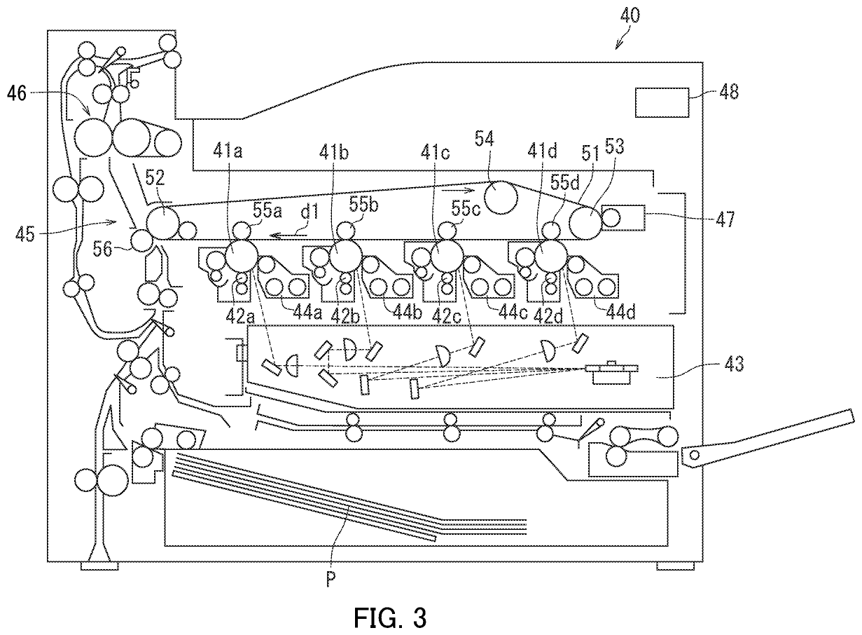

With reference to FIG. 3, an image forming apparatus 40, which is an example of the image forming apparatus according to the second embodiment, is described below.

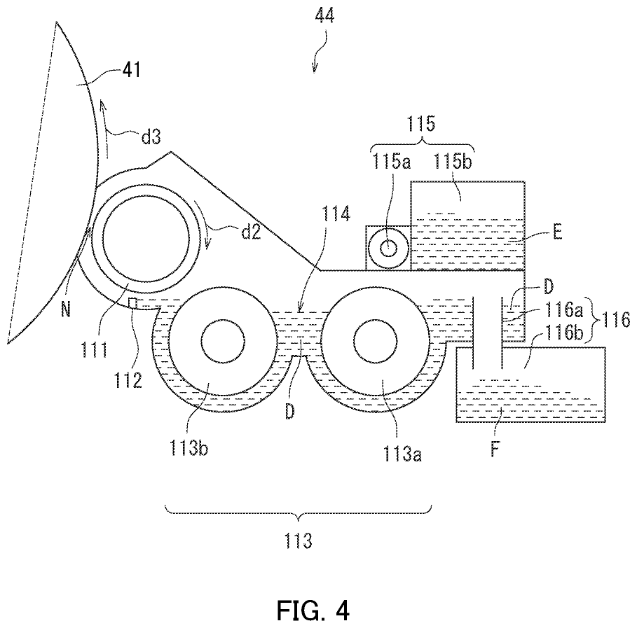

The image forming apparatus 40 illustrated in FIG. 3 includes a developer (an in-use developer D and a replenishment developer E, see FIG. 4), a photosensitive member 41a to a photosensitive member 41d, a charger 42a to a charger 42d, a light exposure device 43, a development device 44a to a development device 44d, a transfer device 45, a fixing device 46, a cleaning device 47, and a controller 48. In the following, the photosensitive member 41a to the photosensitive member 41d are each referred to as photosensitive member 41, the charger 42a to the charger 42d are each referred to as charger 42, and the development device 44a to the development device 44d are each referred to as development device 44 where there is no need to distinguish them.

The in-use developer D includes an initial developer and a replenishment developer E. The initial developer is the developer described in the first embodiment. The replenishment developer E is preferably the developer described in the first embodiment but may be another developer.

Each of the photosensitive members 41 is cylindrical in shape. The photosensitive member 41 includes a metal-made cylindrical body (e.g., a cylindrical conductive substrate) as a core. A photosensitive layer is provided around the core. The photosensitive member 41 is supported in a rotatable manner. The photosensitive member 41 is rotationally driven by a motor (not illustrated).

Each of the chargers 42 charges the circumferential surface of a corresponding one of the photosensitive members 41.

The light exposure device 43 irradiates the charged circumferential surfaces of the photosensitive members 41 with light to form electrostatic latent images on the circumferential surfaces of the photosensitive members 41. For example, the electrostatic latent images are formed on the surface layer portions (photosensitive layers) of the photosensitive members 41 based on image data.

The development devices 44 develop the electrostatic latent images with the in-use developer D. More specifically, the development devices 44 develop the electrostatic latent images formed on the circumferential surfaces of the photosensitive members 41 into toner images with the in-use developer D. The development devices 44 are described later in detail.

The transfer device 45 includes a transfer belt 51, a drive roller 52, a driven roller 53, a tension roller 54, a primary transfer roller 55a to a primary transfer roller 55d, and a secondary transfer roller 56. In the following, the primary transfer roller 55a to the primary transfer roller 55d are each referred to as primary transfer roller 55 where there is no need to distinguish them. The transfer belt 51 is an endless belt wound among the drive roller 52, the driven roller 53, and the tension roller 54. Rotation of the drive roller 52 causes circulation of the transfer belt 51 in the clockwise direction in FIG. 3 (an arrow direction d3 in FIG. 3). The driven roller 53 and the tension roller 54 are rotationally driven by circulation of the transfer belt 51.

Once the toner images are formed on the photosensitive member 41a to the photosensitive member 41d, toner (toner images) attached to the photosensitive member 41a to the photosensitive member 41d is primarily transferred to the transfer belt 51 in a sequential manner by bias (voltage) application to the primary transfer roller 55a to the primary transfer roller 55d. In the manner described above, the toner images in multiple colors are superimposed on the transfer belt 51. After primary transfer, bias (voltage) is applied to the secondary transfer roller 56, thereby secondarily transferring the toner images in multiple colors on the transfer belt 51 to a recording medium P (e.g., printing paper) that is being conveyed. Thereafter, the toner images in multiple colors superimposed on the transfer belt 51 are secondarily transferred in a batch to the recording medium P. In the manner described above, an image constituted by unfixed toner is formed on the recording medium P.

After secondary transfer, the fixing device 46 applies heat and pressure to the toner on the recording medium P to fix the toner to the recording medium P. In the manner described above, an image constituted by the fixed toner is formed on the recording medium P.

The cleaning device 47 cleans toner remaining on the transfer belt 51 after secondary transfer.

The controller 48 electronically controls the operation of the image forming apparatus 40 based on outputs from various sensors. The controller 48 includes a central processing unit (CPU), random-access memory, and a storage device that stores programs therein and that stores specific data therein in a rewritable manner, for example. A user provides an instruction (e.g., an electric signal) to the controller 48 through an input section (not illustrated). The input section is a keyboard, a mouse, or a touch panel, for example.

### <Development Device>

With reference to FIG. 4, the development devices 44 are described next further in detail. FIG. 4 illustrates a development device 44 and the peripheral part thereof in the image forming apparatus 40 illustrated in FIG. 3. The development device 44 includes at least an accommodation section 114. The development device 44 further includes a developer bearing member 111, a restriction blade 112, a plurality of stirring shafts 113, a replenishment section 115, and a discharge section 116. The development device 44 is a development device 44 of trickle development type including the accommodation section 114, the replenishment section 115, and the discharge section 116.

The accommodation section 114 accommodates the in-use developer D and the stirring shafts 113. The in-use developer D accommodated in the accommodation section 114 includes the initial developer. The stirring shafts 113 include a first stirring shaft 113a and a second stirring shaft 113b. The first stirring shaft 113a includes a spiral stirring vane. The second stirring shaft 113b includes a spiral stirring vane that faces in the opposite direction (opposite phase) to the direction in which the spiral stirring vane of the first stirring shaft 113a faces. The first stirring shaft 113a conveys the in-use developer D in a first direction (direction perpendicular to the paper surface in FIG. 4 and a direction from the back to the front of the paper) from one end to the other end of the developer bearing member 111 in the axial direction while stirring the in-use developer D in the accommodation section 114. The second stirring shaft 113b conveys the in-use developer D in a second conveyance direction opposite to the first conveyance direction while stirring the in-use developer D in the accommodation section 114. When the in-use developer D containing a toner and a carrier is stirred, the toner is charged by friction with the carrier and the charged toner is carried by the carrier. The second stirring shaft 113b supplies the in-use developer D to the developer bearing member 111 while conveying the in-use developer D in the second conveyance direction.

The replenishment section 115 is provided above the accommodation section 114. The replenishment section 115 replenishes the accommodation section 114 with the replenishment developer E. The replenishment section 115 includes a replenishment amount adjusting member 115a and a developer container 115b.

The replenishment amount adjusting member 115a controls the replenishment amount of the replenishment developer E to be supplied to the accommodation section 114 from the developer container 115b. The replenishment amount adjusting member 115a is constituted by a screw shaft of which rotation operation is controlled by the controller 48, for example. For example, the replenishment amount of the replenishment developer E can be changed according to the amount of rotation of the screw shaft.

The developer container 115b accommodates the replenishment developer E. The replenishment developer E in the developer container 115b is supplied to the accommodation section 114.

The discharge section 116 discharges the in-use developer D in the accommodation section 114. The discharge section 116 includes a discharge path 116a and a collection container 116b. The discharge path 116a connects the accommodation section 114 and the collection container 116b. When the amount of the in-use developer D in the accommodation section 114 exceeds a specific amount, excess in-use developer D flows into the discharge path 116a from an opening at the upper end of the discharge path 116a. The specific amount is an amount determined according to the position of the upper end of the discharge path 116a, for example. Excess in-use developer D is in-use developer D in an amount in excess of the specific amount, for example. The excess in-use developer D, after entering the discharge path 116a, travels downward within the discharge path 116a due to its own weight and flows into the collection container 116b. Then, the collection container 116b collects the excess in-use developer D as a post collection developer F (collected developer).

In the image forming apparatus 40 (e.g., an unused image forming apparatus 40) before image formation begins, the in-use developer D accommodated in the accommodation section 114 is the initial developer.

Before replenishment of the accommodation section 114 with the replenishment developer E by the replenishment section 115 after image formation begins, the in-use developer D accommodated in the accommodation section 114 is the initial developer. In the accommodation section 114, the stirring shafts 113 stir the initial developer to frictionally charge the toner particles 10 contained in the initial developer. Thereafter, the stirred initial developer is carried by the developer bearing member 111.

When printing by the image forming apparatus 40 is continued, replenishment of the accommodation section 114 with the replenishment developer E and discharge of the in-use developer D from the accommodation section 114 are performed. As such, continuation of printing by the image forming apparatus 40 replaces the in-use developer D accommodated in the accommodation section 114 with the replenishment developer E that is replenished from the replenishment section 115 little by little. Once the replenishment section 115 replenishes the accommodation section 114 with the replenishment developer E, the initial developer and the replenishment developer E are stirred by the stirring shafts 113 in the accommodation section 114, with a result that the toner particles 10 contained in the initial developer and the toner particles 10 contained in the replenishment developer E are frictionally charged. Thereafter, the stirred initial developer and the stirred replenishment developer E are carried by the developer bearing member 111.

The developer bearing member 111 is located in the vicinity of the photosensitive member 41. The developer bearing member 111 includes a magnet roll and a development sleeve. The magnet roll has magnetic poles on at least a surface layer portion thereof. The magnetic poles include an N pole and an S pole based on a permanent magnet, for example. The development sleeve is a non-magnetic cylinder (e.g., an aluminum pipe). The magnet roll is located in the development sleeve (cylinder), and the development sleeve is located on the surface layer portion of the developer bearing member 111. The shaft of the magnet roll, which is nonrotatable, and the development sleeve are connected to each other by a flange in a manner that the development sleeve is rotatable around the magnet roll.

As described previously, the charged toner is carried by the carrier in the accommodation section 114. The developer bearing member 111 (specifically, the development sleeve) attracts the carrier in the accommodation section 114 by the magnetic force thereof while rotating in the clockwise direction in FIG. 4 (an arrow direction d2 in FIG. 4) to carry, on the circumferential surface thereof, the carrier (i.e., the in-use developer D) carrying the toner. Thereafter, a magnetic brush is formed with the in-use developer D carried by the developer bearing member 111.

The restriction blade 112 restricts the thickness of the magnetic brush of the in-use developer D formed on the circumferential surface of the developer bearing member 111 to a specific thickness.

After the thickness of the magnetic brush is restricted by the restriction blade 112, the developer bearing member 111 (specifically, the development sleeve) further rotates in the clockwise direction in FIG. 4 (the arrow direction d2 in FIG. 4) to convey the in-use developer D to a proximal part N. The proximal part N refers to a part of a space between the photosensitive member 41 and the developer bearing member 111 that has the shortest distance therebetween. The photosensitive member 41 rotates in the anticlockwise direction in FIG. 4 (the arrow direction d3 in FIG. 4). Bias (voltage) application to the developer bearing member 111 generates a potential difference between the surface potential of the developer bearing member 111 and the surface potential of the photosensitive member 41. Due to presence of the potential difference, the toner contained in the in-use developer D carried by the developer bearing member 111 moves to the circumferential surface of the photosensitive member 41. In detail, the charged toner contained in the in-use developer D carried by the developer bearing member 111 is attracted by electric force to an electrostatic latent image (e.g., an exposed part of which potential is reduced by light exposure to be lower than that of the non-exposed part) formed on the photosensitive member 41, thereby moving to the electrostatic latent image on the photosensitive member 41. As a result, a toner image is formed on the circumferential surface of the photosensitive member 41.

The image forming apparatus 40 according to the second embodiment has been described so far with reference to FIGS. 3 and 4. However, the image forming apparatus according to the second embodiment is not limited to the above image forming apparatus 40 and may be implemented in various manners within a scope not departing from the gist thereof. For example, some elements of configuration may be omitted from all the elements of configuration indicated in the embodiment. Properties such as material, shape, and dimension of each element of configuration are only examples and not limited particularly. Various alterations can be practiced.

### EXAMPLES

The following provides further specific description of the present disclosure through use of Examples. However, the present disclosure is not limited to the scope of Examples.

### [Measurement of Number Average Primary Particle Diameter]

The number average primary particle diameter of each type of particles (e.g., crosslinked resin particles, non-crosslinked resin particles, silica particles, composite particles, strontium titanate particles, barium titanate particles, and carbon black particles) described in the present examples were measured using a scanning electron microscope (“JSM-7600F”, product of JEOL Ltd., field emission scanning electron microscope). In the measurement of each number average primary particle diameter, equivalent circle diameters (Heywood diameters: diameters of circles having the same areas as projected areas of the primary particles) of 100 primary particles were measured and a number average thereof was obtained. Note that in the present examples, the number average primary particle diameter may be also referred to below as “particle diameter” or “diameter” for short.

### [Coverage Ratio Measurement]

The coverage ratio of spacer particles of toner particles was measured using the aforementioned scanning electron microscope. In detail, the surfaces of the toner particles were observed using the aforementioned scanning electron microscope to determine an area percentage of the spacer particles on the assumption that the surfaces of toner mother particles of the toner particles was 100% by area. In the measurement, the magnification of the scanning electron microscope was set so that the approximately 50 spacer particles (e.g., 50 particles±5 particles) were included in the measurement area.

### <Material>

The following types of particles were prepared as external additive particles of toners and carriers.

### [Resin Particles]

A glass-made reaction vessel equipped with a thermometer (thermocouple), a stirring device, a reflux condenser, and a nitrogen gas inlet tube was set in a water bath (set temperature: 80° C.). Into the reaction vessel, 300.0 parts by mass of ion exchange water and 1.0 part by mass of di-t-butyl peroxide were added. Next, the inside of the reaction vessel was placed in a nitrogen gas atmosphere. In the operation thereafter, the temperature of the contents of the reaction vessel was kept at 80° C. and the inside of the reaction vessel was maintained in the nitrogen gas atmosphere. Next, 0.2 parts by mass of ammonium persulfate and 60.0 parts by mass of a monomer mixture were dripped into the reaction vessel over 1 hour under stirring of the contents of the reaction vessel. The monomer mixture was a mixture of 10% by mol of styrene, 40% by mol of butyl methacrylate, and 50% by mol of divinylbenzene. Next, the contents of the reaction vessel was caused to react while a reaction solution was stirred. In the reaction, the reaction temperature X was set to 100° C., the reaction time Y was set to 3 hours, and the stirring speed Z was set to 1250 rpm. The reaction solution (emulsion solution) after the reaction was dried to obtain crosslinked resin particles (number average primary diameter: 35 nm).

Non-crosslinked resin particles (number average primarily particle diameter: 35 nm) were prepared according to the same method as that for preparing the abovementioned crosslinked resin particles (number average primarily particle diameter: 35 nm) in all aspects other than that the monomer mixture was changed to have a composition of 20 mole percent styrene and 80 mole percent butyl methacrylate.

Crosslinked resin particles and non-crosslinked resin particles both with a number average primary particle diameter of 50 nm to 150 nm were prepared according to the same method as that for preparing the abovementioned crosslinked resin particles (number average primarily particle diameter: 35 nm) and the non-crosslinked resin particles (number average primarily particle diameter: 35 nm) in all aspects other than that the reaction temperature X, the reaction time Y, and the stirring speed Z were changed as shown below in Table 1.

TABLE 1

| Particle | Reaction | Reaction | Stirring |
|---|---|---|---|
| diameter | temperature | time Y | speed Z |
| [nm] | X [° C.] | [hour] | [rpm] |
| 35 | 100 | 3 | 1,250 |
| 50 | 100 | 3 | 1,000 |
| 60 | 100 | 3 | 950 |
| 80 | 100 | 4 | 900 |
| 100 | 100 | 4 | 750 |
| 120 | 100 | 4 | 600 |
| 150 | 100 | 5 | 620 |

### [Silica Particles]

A raw material mixture was obtained by charging into a vessel and mixing finely pulverized silica, a carbon powder as a reductant, and an appropriate amount of water. Next, the raw material mixture was heated to approximately 1800° C. using an incinerator to generate a SiO₂ gas. Next, the generated SiO₂ gas was forcedly cooled using cooled air (flow rate X: 80 m³/hour) to precipitate silica fine particles. Next, the precipitated silica fine particles were collected using a bag filter. Next, aminopropylethoxysilane and silicone oil were added to the collected silica fine particles. Next, the silica fine particles after the addition was heated to obtain a solid. Next, the resultant solid was crashed using an FM mixer to obtain silica particles D with a number average primary particle diameter of 100 nm.

Silica particles A to C and E were prepared according to the same method as that for preparing the silica particles D in all aspects other than that the flow rate X of the cooled air was changed as shown below in Table 2.

TABLE 2

| Silica particles | Cooled air flow rate X [m³/hour] | Particle diameter [nm] |
|---|---|---|
| A | 140 | 40 |
| B | 110 | 60 |
| C | 85 | 80 |
| D | 80 | 100 |
| E | 65 | 140 |

### [Composite Particles]

Into a vessel, 200 g of toluene as a solvent, 100 g of dimethylpolysiloxane, and 100 g of 3-aminopropyltrimethoxysilane were added. A toluene solution was obtained by dissolving the components other than the solvent in the solvent. Next, 3600 g of toluene was added (10-time dilution) to 400 g of the toluene solution to obtain a diluted toluene solution. Next, the diluted toluene solution was gradually dripped into 200 g of silica fine particles (“AEROSIL (registered Japanese trademark) R 972”, product of NIPPON AEROSIL CO., LTD., fumed silica) under ultrasonic irradiation and stirring for 30 minutes to obtain a mixture. Next, the resultant mixture was heated in a thermostatic chamber at 150° C. while a rotary evaporator was used for pressure reduction to distill the toluene in the mixture, thereby obtaining a solid. Next, the resultant solid was dried using a reduced pressure dryer set at a temperature of 50° C. to obtain a dried solid. The drying was continued until volatile components were sufficiently removed from the solid and the solid did not lose any more weight. Next, the dried solid was heated at 200° C. for 3 hours under a nitrogen air flow using an electric furnace to obtain a powder. Next, the resultant powder was crashed using a jet mill (flow rate: 1 m³/min) and collected using a bag filter, thereby obtaining silica particles (also referred to below as small-diameter silica particles) with a number average primary particle diameter of 20 nm.

A vessel of a mixer (“HIVIS MIX (registered Japanese trademark) Type 2P-1”, product of PRIMIX Corporation) was charged with 700 g of one type of the aforementioned crosslinked particles (number average primary particle diameter: 35 nm) and 15 g of methyl hydrogen polysiloxane, and mixing and stirring were carried out for 60 minutes. In the mixing and stirring, the stirring speed of the mixer was set to 20 rpm for both the spinning speed and the revolving speed. Thereafter, 707 g of the aforementioned small-diameter silica particles (number average primary particle diameter: 20 nm) was further added into the mixer and mixing and stirring were carried out for 30 minutes. In the mixing and stirring, the stirring speed of the mixer was set to 20 rpm for both the spinning speed and the revolving speed. Through the above, the small-diameter silica particles (number average primary particle diameter: 20 nm) were attached to the surfaces of the crosslinked resin particles (number average primary particle diameter: 35 nm) covered with methyl hydrogen polysiloxane. Thereafter, the internal pressure of the mixer was reduced for 2 hours using a rotary pump while the mixing and stirring by the mixer was kept continued, thereby drying the contents of the vessel. Thus, composite particles A were obtained that included the resin particles and the silica particles attached to the surfaces of the resin particles. The resultant composite particles A had a number average primary particle diameter of 50 nm.

Composite particles B to D were prepared according to the same method as that for preparing the composite particles A in all aspects other than that the type of the crosslinked resin particles and the amount of the small-diameter silica particles used relative to 100 parts by mass of the crosslinked resin particles were changed as shown below in Table 3.

TABLE 3

| | Crosslinked resin | | | | |
|---|---|---|---|---|---|
| | particles | | Silica particles | | |
| | | Particle | | Particle | Particle |
| Composite | Part by | diameter | Part by | diameter | diameter |
| particles | mass | [nm] | mass | [nm] | [nm] |
| A | 100 | 35 | 101 | 20 | 50 |
| B | 100 | 60 | 59 | 20 | 76 |
| C | 100 | 80 | 44 | 20 | 96 |
| D | 100 | 100 | 35 | 20 | 120 |

### [Barium Titanate Particles]

As barium titanate particles used for developer preparation, those shown below in Table 4 were prepared.

TABLE 4
Barium titanate particles

| | | Particle |
|---|---|---|
| | Product | diameter |
| Manufacturer | name | [nm] |
| SAKAI CHEMICAL INDUSTRY CO., LTD. | BT-01 | 102 |
| SAKAI CHEMICAL INDUSTRY CO., LTD. | BT-03 | 304 |
| SAKAI CHEMICAL INDUSTRY CO., LTD. | BT-05 | 495 |
| SAKAI CHEMICAL INDUSTRY CO., LTD. | custom-made | 83 |
| | item | |
| SAKAI CHEMICAL INDUSTRY CO., LTD. | custom-made | 588 |
| | item | |

### <Study 1>

First, the need for the spacer particles in the toner particles and the need for the strontium titanate particles in the carrier particles were studied.

### [Developer Preparation]

Developers (A-1) to (A-7) were prepared. Table 5 shows the materials and amounts of toners (T-1) to (T-5) used in the developers (A-1) to (A-7). Table 6 shows the materials and amounts of carriers (C-1) and (C-2) used in the developers (A-1) to (A-7). Table 7 shows the compositions of the coat layers of the carriers (C-1) and (C-2) used in the developers (A-1) to (A-7).

TABLE 5

| | Toner | | | | | | | | |
|---|---|---|---|---|---|---|---|---|---|
| | | | External additive particles | | | | | | |
| | | Mother | | SiO₂ | | Spacer particles | | | |
| | | particles | Al₂O₃ | | Diameter | | | Coverage | Diameter |
| Developer | Type | Part | Part | Part | [nm] | Type | Part | [% by area] | [nm] |
| A-1 | T-1 | 100 | 0.75 | 1 | 20 | — | — | — | — |
| A-2 | T-1 | 100 | 0.75 | 1 | 20 | — | — | — | — |
| A-3 | T-2 | 100 | 0.75 | 1 | 20 | Resin (C) | 0.5 | 14.2 | 60 |
| A-4 | T-2 | 100 | 0.75 | 1 | 20 | Resin (C) | 0.5 | 14.2 | 60 |
| A-5 | T-3 | 100 | 0.75 | 1 | 20 | Resin (NC) | 0.5 | 14.2 | 60 |
| A-6 | T-4 | 100 | 0.75 | 1 | 20 | SiO₂ | 0.5 | 6.4 | 60 |
| A-7 | T-5 | 100 | 0.75 | 1 | 20 | Composite C | 0.5 | 7.4 | 96 |

TABLE 6

| | Carrier SrTiO₃ | | | | | | |
|---|---|---|---|---|---|---|---|
| | | Overall composition | | | | | |
| | | Carrier cores | | Coat | SrTiO₃ | | |
| Devel- | | | Diameter | layers | | Diameter | Distance |
| oper | Type | Part | [μm] | Part | Part | [μm] | L [nm] |
| A-1 | C-1 | 100 | 40 | 1.5 | — | — | −20 |
| A-2 | C-2 | 100 | 40 | 1.5 | 0.04 | 30 | −50 |
| A-3 | C-1 | 100 | 40 | 1.5 | — | — | 40 |
| A-4 | C-2 | 100 | 40 | 1.5 | 0.04 | 30 | 10 |
| A-5 | C-2 | 100 | 40 | 1.5 | 0.04 | 30 | 10 |
| A-6 | C-2 | 100 | 40 | 1.5 | 0.04 | 30 | 10 |
| A-7 | C-2 | 100 | 40 | 1.5 | 0.04 | 30 | 46 |

TABLE 7

| | Carrier | | | | | | | |
|---|---|---|---|---|---|---|---|---|
| | | Coat layer composition | | | | | | |
| | | Silicone resin | | BaTiO₃ | | Carbon black particles | | |
| Developer | Type | Type | Part | Part | Diameter [nm] | Type | Part | Diameter [nm] |
| A-1 | C-1 | KR-255 | 100 | 20 | 304 | EC300J | 8 | 39.5 |
| A-2 | C-2 | KR-255 | 100 | 20 | 304 | EC300J | 8 | 39.5 |
| A-3 | C-1 | KR-255 | 100 | 20 | 304 | EC300J | 8 | 39.5 |
| A-4 | C-2 | KR-255 | 100 | 20 | 304 | EC300J | 8 | 39.5 |
| A-5 | C-2 | KR-255 | 100 | 20 | 304 | EC300J | 8 | 39.5 |
| A-6 | C-2 | KR-255 | 100 | 20 | 304 | EC300J | 8 | 39.5 |
| A-7 | C-2 | KR-255 | 100 | 20 | 304 | EC300J | 8 | 39.5 |

The terms in Tables 5 to 7 mean as follows. Also, “Part” under “Silicone resin” in Table 7 indicates part by mass in terms of solid content. The same definitions of terms apply to the following tables.
“Diameter”: number average primary particle diameter
“Part”: parts by mass
SrTiO₃: strontium titanate particles
BaTiO₃: barium titanate particles
Al₂O₃: aluminum oxide particles
SiO₂: silica particles
Resin (C): crosslinked resin particles
Resin (NC): non-crosslinked resin particles
Composite A to D: composite particles A to D

### [Preparation of Developer (A-4)]

The following describes a method for preparing the developer (A-4) and then describes a method for preparing the other developers.

### <Toner Preparation>

The toner (T-2) used in preparation of the developer (A-4) was prepared according to the following method.

### (Synthesis of Non-Crystalline Polyester Resin (R1))

A non-crystalline polyester resin (R1) used as a binder resin in toner mother particle preparation was synthesized according to the following method. First, a reaction vessel equipped with a thermometer (thermocouple), a dewatering conduit, a nitrogen gas inlet tube, and a stirring device (stirring impeller) was set in an oil bath. The reaction vessel was charged with 1575 g of bisphenol A propylene oxide adduct (BPA-PO), 163 g of bisphenol A ethylene oxide adduct (BPA-EO), 377 g of fumaric acid, and 4 g of a catalyst (dibutyl tin oxide). Subsequently, the inside of the reaction vessel was placed in a nitrogen atmosphere and the internal temperature of the reaction vessel was raised to 220° C. using the oil bath under stirring of the contents of the reaction vessel. A polymerization reaction of the contents of the reaction vessel was caused for 8 hours while the byproduct water was distilled in a nitrogen atmosphere at a temperature of 220° C. Subsequently, the internal pressure of the reaction vessel was reduced and the polymerization reaction of the contents of the reaction vessel was further caused in the reduced pressure atmosphere (pressure: 7999 Pa) at a temperature of 220° C. Subsequently, the internal temperature of the reaction vessel was reduced to 210° C. and 336 g of trimellitic anhydride was added into the reaction vessel. The contents of the reaction vessel were then caused to react in the reduced pressure atmosphere (pressure: 7999 Pa) at a temperature of 210° C. The reaction time was adjusted so that a non-crystalline polyester resin (R1) being a reaction product had the following physical properties. Thereafter, the reaction product was taken out of the reaction vessel and cooled to obtain the non-crystalline polyester resin (R1) with the following physical properties. Note that the resultant polyester resin (R1) was determined to be non-crystalline because an endothermic peak was not definitely identified on an endothermic curve of the polyester resin (R1) plotted using a differential scanning calorimeter to disable determination of a definite melting point.

### (Physical Properties of Non-Crystalline Polyester Resin (R1))

Softening point (Tm): 100° C.
Glass transition point (Tg): 50° C.
Mass average molecular weight (Mw): 30,000
Acid value: 15 mgKOH/g
Hydroxyl value: 30 mgKOH/g

### (Toner Mother Particle Preparation)

Using an FM mixer (“FM-10B”, product of Nippon Coke & Engineering Co., Ltd.), 100 parts by mass of a binder resin, 4 parts by mass of a colorant, 1 part by mass of a charge control agent, and 5 parts by mass of a releasing agent were mixed to yield a mixture. The binder resin used was the non-crystalline polyester resin (R1). The colorant used was a copper phthalocyanine blue pigment (C.I. Pigment Blue 15:3). The charge control agent used was a quaternary ammonium salt (“BONTRON (registered Japanese trademark) P-51”, product of ORIENT CHEMICAL INDUSTRIES CO., LTD.). The releasing agent used was a carnauba wax (“SPECIAL CARNAUBA WAX No. 1”, product of S. Kato & Co.). The resultant mixture was melt-kneaded using a twin screw extruder (“PCM-30”, product of Ikegai Corp.) to obtain a melt-kneaded product. The resultant melt-kneaded product was pulverized using a mechanical pulverizer (“TURBO MILL”, product of FREUND-TURBO CORPORATION) to obtain a pulverized product. The resultant pulverized product was classified using a classifier (“ELBOW JET”, product of Nittetsu Mining Co., Ltd.). Through the above, toner mother particles in powder form with a volume median diameter of 6.8 μm were obtained.

### (External Additive Addition to Toner Mother Particles)

Using an FM mixer (“FM-10B”, product of Nippon Coke & Engineering Co., Ltd.), 100.0 parts by mass of the toner mother particles obtained as above, 0.5 parts by mass of one type of the aforementioned crosslinked resin particles (number average primary particle diameter: 60 nm), 1.0 part by mass of the aforementioned small-diameter silica particles (number average primary particle diameter: 20 nm), and 0.75 parts by mass of aluminum oxide particles (“AEROXIDE (registered Japanese trademark) Alu C805”, product of NIPPON AEROSIL CO., LTD., BET specific surface area: 75 to 105 m²/g) were mixed at 4000 rpm for 5 minutes to obtain a mixture. The resultant mixture was sifted using a 200-mesh sieve (opening 75 μm) to obtain the toner (T-2). Note that the aforementioned aluminum oxide particles had a number average primary particle diameter of greater than 300 nm and were therefore an external additive not corresponding to the spacer particles.

### <Carrier Preparation>

The carrier (C-2) used in preparation of the developer (A-4) was prepared according to the following method.

### (Preparation of Coating Liquid (L1))

A coating liquid (L1) was prepared for use in formation of coat layers of the carriers. A stainless steel vessel was charged with 361.2 g of a silicone resin solution (solid content: 161.1 g), 36.2 g of barium titanate particles, 14.4 g of carbon black, and 1444.8 g of toluene. The vessel contents were mixed using a homogenizer to obtain the coating liquid (L1). The silicone resin solution used was “KR-255” (product of Shin-Etsu Chemical Co., Ltd., solid content: methylphenyl silicone resin, solid concentration: 50% by mass). The barium titanate particles used were “BT-01” (product of SAKAI CHEMICAL INDUSTRY CO., LTD., number average primary particle diameter: 304 nm) was used. The carbon black used was “KETJEN BLACK (registered Japanese trademark) EC300J” (product of Lion Specialty Chemicals Co., Ltd., number average primary particle diameter: 39.5 nm) being a conductive carbon black.

### (Carrier Mother Particle Preparation)

The coating liquid (L1) was sprayed toward 5000 g of carrier cores while the carrier cores were allowed to flow using a fluidized bed coating apparatus (“FD-MP-01 Type D”, product of Powrex Corporation). The carrier cores used were manganese ferrite cores (product of DOWA IP CREATION CO., LTD., volume median diameter: 40 μm, saturation magnetization: 67 emu/g). Coating was done under conditions of a fed air temperature of 75° C., a fed flow rate of 0.3 m 3/min, and a rotor rotational speed of 400 rpm. The amount of the coating liquid (L1) loaded into the fluidized bed coating apparatus was adjusted so that the coat layer/core ratio was 1.5% by mass (i.e., so that the mass of the coat layers formed by heating was 15 g relative to 1000 g of the carrier cores). Carrier cores coated with the coating liquid (L1) were obtained by the spraying. Next, the carrier cores coated with the coating liquid (L1) coated thereon were baked at 200° C. for 1 hour using an electric furnace to form coat layers on the surfaces of the carrier cores. Through the above, carrier mother particles were obtained.

### (External Additive Addition to Carrier Mother Particles)

Using a Rocking Mixer (registered Japanese trademark) “RM-10” produced by AICHI ELECTRIC CO., LTD., 100.00 parts by mass of the carrier mother particles obtained as above and 0.04 parts by mass of strontium titanate particles were mixed for 30 minutes to attach the strontium titanate particles to the surfaces of the carrier mother particles. In the manner described above, the carrier (C-2) containing carrier particles was obtained. The strontium titanate particles used were non-doped strontium titanate particles (particle size adjusted product of “SW-100” produced by Titan Kogyo, Ltd.) with the particle size adjusted to a number average primary particle diameter of 30 nm.

### <Developer Preparation>

Using a Rocking Mixer (registered Japanese trademark) (“RM-10” product of AICHI ELECTRIC CO., LTD.), 92 parts by mass of the carrier (C-2) and 8 parts by mass of the toner (T-2) were mixed for 30 minutes. In the manner described above, the developer (A-4) to be used as an initial developer was obtained. The developer (A-4) had a toner concentration of 8% by mass.

The distance L of the developer (A-4) was 10 nm as indicated below.

Distance L=(number average primary particle diameter (60 nm) of spacer particles)−(number average primary particle diameter (20 nm) of first silica particles (small-diameter silica particles))+(number average primary particle diameter (30 nm) of strontium titanate particles)=10 nm

Separately, 10 parts by mass of the carrier (C-2) and 90 parts by mass of the toner (T-2) were mixed for 30 minutes using a Rocking Mixer (registered Japanese trademark) (“RM-10” product of AICHI ELECTRIC CO., LTD.). In the manner described above, a replenishment developer (toner concentration: 90% by mass) was obtained that corresponded to the developer (A-4). In evaluation described below, the developer (A-4) being an initial developer and the above replenishment developer were used as a set.

### [Preparation of Developers (A-1) to (A-3) and (A-5) to (A-7)]

Developers (A-1) to (A-3) and (A-5) to (A-7) each used as an initial developer were prepared according to the same method as that for preparing the developer (A-4) in all aspects other than the following changes. In the preparation of the developers (A-1) to (A-3) and (A-5) to (A-7), the type of the spacer particles used in the external additive addition to the toner mother particles was changed to those shown in Table 5 and use or non-use of the strontium titanate particles for external additive addition to the carrier mother particles was changed as shown in Table 6. Note that “-” in the tables indicates that the corresponding component was not used. In the preparation of the carrier (C-1) for which “-” is indicated for the strontium titanate particles, external additive addition itself was not carried out.

For each of the developers (A-1) to (A-3) and (A-5) to (A-7), a corresponding replenishment developer (toner concentration: 90% by mass) was also prepared separately. In evaluation described below, sets of the developers (A-1) to (A-3) and (A-5) to (A-7) each being an initial developer and the corresponding replenishment developers were used.

### [Evaluation 1]

With respect to each of the developers (A-1) to (A-7), image density, fogging, and fixability were evaluated according to the following methods. Evaluation results are shown below in Tables 8 and 9.

### <Evaluation Apparatus>

As an evaluation apparatus, “TASKalfa 7054ci” produced by KYOCERA Document Solutions Inc. was used. The evaluation apparatus included an amorphous silicon drum being a photosensitive member and a development device using a two-component developer. The development device had the configuration described with reference to FIG. 4.

One of the developers in Table 8 was charged to an accommodation section of the development device as an initial developer. The corresponding replenishment developer was also charged to a replenishment section of the development device.

### <Formation of Images A and B>

Printing was carried out in an environment at a temperature of 23° C. and a relative humidity of 65%. Using the evaluation apparatus, an image (character pattern image with a printing rate of 4%) was printed intermittently (intermittent printing) on 1,000 sheets of paper (first consecutive printing). Note that intermittent printing was repetition of a series of operations of consecutive printing on 7 sheets of the paper and temporary stop thereafter. After the first consecutive printing, an image A (image including a solid image area and a blank area) was printed on one sheet of paper using the evaluation apparatus. Next, an image (character pattern image with a printing rate of 4%) was printed intermittently on 99,000 sheets of paper (second consecutive printing). After the second consecutive printing, an image B (image including a solid image area and a blank area) was printed on one sheet of paper using the evaluation apparatus.

### <Image Density>

The reflection density (image density) of the solid image area of each of the images A and B was measured using a reflectance densitometer (“SpectroEye (registered Japanese trademark)”, product of X-Rite Inc.). The image densities of the images A and B were taken to be IDik and Ithook, respectively. Image density was evaluated according to the following criteria.

### (Criteria of Image Density)

A (very good): image density of at least 1.30
B (good): image density of at least 1.00 and less than 1.30
C (poor): image density of less than 1.00

### <Fogging>

The reflection density of a sheet of non-printed paper and the reflection density of the blank area of the sheet with the image A or the image B printed thereon were measured using a white light meter (“TC-6DS”, product of Tokyo Denshoku Co., Ltd.). A fogging density was calculated using an equation “fogging density=(reflection density of blank area)−(reflection density of sheet of non-printed paper)”. The fogging densities of the image A and the image B were taken to be FDik and FD look, respectively. Fogging density was evaluated according to the following criteria.

### (Criteria of Fogging Density)

A (very good): fogging density of less than 0.010
B (good): fogging density of at least 0.010 and less than 0.020
C (poor): fogging density of at least 0.020

### <Fixability>

Using the image forming apparatus after the printing of the image B, an image C (image including a solid image area and a blank area) was printed on one sheet of paper. In the printing of the image C, the image forming apparatus was set so that the image density of the solid image area was 1.2. In the setting of the image forming apparatus, the result of the measured fogging density ID₁₀₀ₖ was used as a reference. Next, the solid image area of the image C was rubbed using an eraser (eraser test). In the eraser test, the eraser with a 1-kg load applied thereto was moved back and forth over the solid image three times. After the eraser test, the image density of the solid image area of the image C was measured. Next, a rate of the image density of the solid image area after the eraser test to the image density (1.2) of the solid image area before the eraser test was calculated and taken to be an evaluation value. Fixability was evaluated according to the following criteria.

### (Criteria of Fixability)

A (best): evaluation value of at least 90%
B (very good): evaluation value of at least 80% and less than 90%
C (good): evaluation value of at least 70% and less than 80%
D (poor): evaluation value of less than 70%<

### Total Evaluation>

Total evaluation was carried out based on each evaluation result of image density (ID₁ₖ and ID₁₀₀ₖ), fogging (FD₁ₖ and FD₁₀₀ₖ), and fixability. The criteria were shown below.

### (Criteria of Total Evaluation)

A (very good): rated as “very good” or “best” in all of image density, fogging, and fixability
B (good): rated as “good” in at least one of image density, fogging, and fixability and rated as “poor” in none of image density, fogging, and fixability
C (poor): rated as “poor” in at least one of image density, fogging, and fixability

TABLE 8

| | | Image density | | | | Fogging | | | |
|---|---|---|---|---|---|---|---|---|---|
| | Developer | ID₁ₖ | Rate | ID₁₀₀ₖ | Rate | FD₁ₖ | Rate | FD₁₀₀ₖ | Rate |
| Comparative Example 1 | A-1 | 0.92 | C | 0.88 | C | 0.007 | A | 0.024 | C |
| Comparative Example 2 | A-2 | 1.31 | A | 0.95 | C | 0.006 | A | 0.022 | C |
| Comparative Example 3 | A-3 | 0.97 | C | 1.32 | A | 0.005 | A | 0.007 | A |
| Example 1 | A-4 | 1.32 | A | 1.33 | A | 0.003 | A | 0.005 | A |
| Example 2 | A-5 | 1.33 | A | 1.33 | A | 0.003 | A | 0.006 | A |
| Example 3 | A-6 | 1.32 | A | 1.32 | A | 0.002 | A | 0.005 | A |
| Example 4 | A-7 | 1.34 | A | 1.32 | A | 0.004 | A | 0.005 | A |

TABLE 9

| | | Fixability | | |
|---|---|---|---|---|
| | | Evaluation | | Total |
| | Developer | value | Rate | evaluation |
| Comparative Example 1 | A-1 | 92% | A | C |
| Comparative Example 2 | A-2 | 93% | A | C |
| Comparative Example 3 | A-3 | 92% | A | C |
| Example 1 | A-4 | 92% | A | A |
| Example 2 | A-5 | 91% | A | A |
| Example 3 | A-6 | 78% | C | B |
| Example 4 | A-7 | 86% | B | A |

As shown in Tables 1 to 9, the developers (A-4) to (A-7) of Examples 1 to 4 each had Features X. As a result, each of the developers (A-4) to (A-7) formed images with desired image density and inhibited occurrence of fogging.

By contrast, the developers (A-1) and (A-2) of Comparative Examples 1 and 2 each contained toner particles of which external additive particles did not include the spacer particles. As a result, the developers (A-1) or (A-2) formed images with insufficient image density and caused fogging after the consecutive printing of 100,000 sheets of the paper.

The developers (A-2) and (A-3) of Comparative Examples 2 and 3 each contained a carrier not including the strontium titanate particles. As a result, with the developers (A-2) or (A-3), the image density was insufficient after the consecutive printing on 1000 sheets of the paper.

According to the results of the developers (A-1) to (A-7), it can be determined that as a result of the toner particles including the spacer particles and the carrier particles including the strontium titanate particles, images with desired image density and less fogging can be formed.

Note that the developer (A-6) of Example 3 contained large-diameter silica particles as the spacer particle. As a result, the developer (A-6) had slightly low fixability although it was within the range of practical use.

### <Study 2>

Next, further study was carried out with various conditions changed.

### [Developer Preparation]

Developers (A-8) to (A-32) (toner density: 8% by mass) were prepared according to the same method as that for preparing the developers (A-1) to (A-7) in all aspects other than the following changes. In the preparation of the developers (A-8) to (A-32), the type and particle diameter of the spacer particles of the toner particles, the particle diameter of the carrier cores, the mass of the coat layers, the number average primary particle diameter and amount of the strontium titanate particles, and the amount and particle diameter of the barium titanate particles were changed as shown below in Tables 10 to 12.

In the preparation of the developer (A-12), a mixture was used as the spacer particles that was obtained by mixing crosslinked resin particles (number average primary particle diameter: 35 nm) and crosslinked resin particles (number average primary particle diameter: 80 nm) at a ratio of 1:2. For the developer (A-12), the number average primary particle diameter of the spacer particles was set to “35 nm×1/3+80 nm×2/3=65 nm”.

For the developers (A-8), (A-11), and (A-23), manganese ferrite cores (product of DOWA IP CREATION CO., LTD., volume median diameter: 20 μm) were used as the carrier cores. For the developers (A-10), (A-13), (A-16), (A-19), (A-22), and (A-25), manganese ferrite cores (product of DOWA IP CREATION CO., LTD., volume median diameter: 60 μm) were used as the carrier cores.

For the developer (A-30), “KR-301” (product of Shin-Etsu Chemical Co., Ltd., solid content: methylphenyl silicone resin, solid concentration: 40% by mass) was used as the silicone resin. For the developer (A-31), “ES-1001N” (product of Shin-Etsu Chemical Co., Ltd., solid content: epoxy resin-modified silicone resin, solid concentration: 45% by mass) was used as the silicone resin. For the developer (A-32), “MA100” (product of Mitsubishi Chemical Corporation, number average primary particle diameter: 24.0 nm) was used as the carbon black.

For the developers (A-8), (A-10), (A-12) to (A-15), (A-18) to (A-20), (A-23), (A-24), and (A-27), strontium titanate particles with a number average primary particle diameter of 20 nm or 50 nm were used. These strontium titanate particles were a particle size adjusted product of non-doped strontium titanate particles (“SW-100”, product of Titan Kogyo, Ltd.).

Note that respective corresponding replenishment developers (toner density: 90% by mass) were also prepared separately for the developers (A-8) to (A-32). Sets of the developers (A-8) to (A-32) each being an initial developer and the respective corresponding replenishment developers were used in evaluation described below.

TABLE 10

| | Toner | | | | | | | | |
|---|---|---|---|---|---|---|---|---|---|
| | | | External additive particles | | | | | | |
| | | | | | | Spacer particles | | | |
| | | Mother | | SiO₂ | | | | Coverage | |
| | | particles | Al₂O₃ | | Diameter | | | ratio [% | Diameter |
| Developer | Type | Part | Part | Part | [nm] | Type | Part | by area] | [nm] |
| A-8 | T-6 | 100 | 0.75 | 1 | 20 | Resin (C) | 0.5 | 24.3 | 35 |
| A-9 | T-7 | 100 | 0.75 | 1 | 20 | Resin (C) | 0.5 | 14.2 | 60 |
| A-10 | T-8 | 100 | 0.75 | 1 | 20 | Resin (C) | 0.5 | 10.6 | 80 |
| A-11 | T-9 | 100 | 0.75 | 1 | 20 | Resin (C) | 0.5 | 7.1 | 120 |
| A-12 | T-10 | 100 | 0.75 | 1 | 20 | Resin (C) | 0.5 | 13.1 | 65 |
| | | | | | | | | | (35 + 80) |
| A-13 | T-11 | 100 | 0.75 | 1 | 20 | Resin (NC) | 0.5 | 24.3 | 35 |
| A-14 | T-12 | 100 | 0.75 | 1 | 20 | Resin (NC) | 0.5 | 14.2 | 60 |
| A-15 | T-13 | 100 | 0.75 | 1 | 20 | Resin (NC) | 0.5 | 10.6 | 80 |
| A-16 | T-14 | 100 | 0.75 | 1 | 20 | Resin (NC) | 0.5 | 7.1 | 120 |
| A-17 | T-15 | 100 | 0.75 | 1 | 20 | SiO₂ | 0.5 | 9.7 | 40 |
| A-18 | T-16 | 100 | 0.75 | 1 | 20 | SiO₂ | 0.5 | 6.4 | 60 |
| A-19 | T-17 | 100 | 0.75 | 1 | 20 | SiO₂ | 0.5 | 4.8 | 80 |
| A-20 | T-18 | 100 | 0.75 | 1 | 20 | SiO₂ | 0.5 | 3.9 | 100 |
| A-21 | T-19 | 100 | 0.75 | 1 | 20 | SiO₂ | 0.5 | 2.8 | 140 |
| A-22 | T-20 | 100 | 0.75 | 1 | 20 | Composite A | 0.5 | 12.1 | 50 |
| A-23 | T-21 | 100 | 0.75 | 1 | 20 | Composite B | 0.5 | 8.6 | 76 |
| A-24 | T-22 | 100 | 0.75 | 1 | 20 | Composite C | 0.5 | 7.4 | 96 |
| A-25 | T-23 | 100 | 0.75 | 1 | 20 | Composite D | 0.5 | 5.9 | 120 |
| A-26 | T-24 | 100 | 0.75 | 1 | 20 | Resin (C) | 0.5 | 5.7 | 150 |
| A-27 | T-25 | 100 | 0.75 | 1 | 20 | Resin (NC) | 0.5 | 17.0 | 50 |
| A-28 | T-2 | 100 | 0.75 | 1 | 20 | Resin (C) | 0.5 | 14.2 | 60 |
| A-29 | T-2 | 100 | 0.75 | 1 | 20 | Resin (C) | 0.5 | 14.2 | 60 |
| A-30 | T-2 | 100 | 0.75 | 1 | 20 | Resin (C) | 0.5 | 14.2 | 60 |
| A-31 | T-2 | 100 | 0.75 | 1 | 20 | Resin (C) | 0.5 | 14.2 | 60 |
| A-32 | T-2 | 100 | 0.75 | 1 | 20 | Resin (C) | 0.5 | 14.2 | 60 |

TABLE 11

| | Carrier | | | | | | |
|---|---|---|---|---|---|---|---|
| | | Overall configuration | | | | | |
| | | Carrier cores | | Coat | SrTiO₃ | | |
| | | | Part | layers | | Diameter | Distance |
| Developer | Type | Part | [μm] | Part | Part | [nm] | L [nm] |
| A-8 | C-3 | 100 | 20 | 1.0 | 0.01 | 20 | −5 |
| A-9 | C-4 | 100 | 40 | 2.0 | 0.04 | 30 | 10 |
| A-10 | C-5 | 100 | 60 | 3.0 | 0.1 | 50 | 10 |
| A-11 | C-6 | 100 | 20 | 1.0 | 0.04 | 30 | 70 |
| A-12 | C-7 | 100 | 40 | 2.0 | 0.1 | 50 | −5 |
| A-13 | C-8 | 100 | 60 | 3.0 | 0.01 | 20 | −5 |
| A-14 | C-9 | 100 | 20 | 2.0 | 0.01 | 50 | −10 |
| A-15 | C-10 | 100 | 40 | 3.0 | 0.04 | 20 | 40 |
| A-16 | C-11 | 100 | 60 | 1.0 | 0.1 | 30 | 70 |
| A-17 | C-12 | 100 | 20 | 3.0 | 0.1 | 30 | −10 |
| A-18 | C-13 | 100 | 40 | 1.0 | 0.01 | 50 | −10 |
| A-19 | C-14 | 100 | 60 | 2.0 | 0.04 | 20 | 40 |
| A-20 | C-15 | 100 | 20 | 2.0 | 0.1 | 20 | 60 |
| A-21 | C-16 | 100 | 40 | 3.0 | 0.01 | 30 | 90 |
| A-22 | C-17 | 100 | 60 | 1.0 | 0.04 | 30 | 0 |
| A-23 | C-18 | 100 | 20 | 3.0 | 0.04 | 50 | 6 |
| A-24 | C-19 | 100 | 40 | 1.0 | 0.1 | 20 | 56 |
| A-25 | C-20 | 100 | 60 | 2.0 | 0.01 | 30 | 70 |
| A-26 | C-6 | 100 | 20 | 1.0 | 0.04 | 30 | 100 |
| A-27 | C-9 | 100 | 20 | 2.0 | 0.01 | 50 | −20 |
| A-28 | C-21 | 100 | 40 | 1.5 | 0.04 | 30 | 10 |
| A-29 | C-22 | 100 | 40 | 1.5 | 0.04 | 30 | 10 |
| A-30 | C-23 | 100 | 40 | 1.5 | 0.04 | 30 | 10 |
| A-31 | C-24 | 100 | 40 | 1.5 | 0.04 | 30 | 10 |
| A-32 | C-25 | 100 | 40 | 1.5 | 0.04 | 30 | 10 |

TABLE 12

| | Carrier | | | | | | | |
|---|---|---|---|---|---|---|---|---|
| | | Coat layer composition | | | | | | |
| | | Silicone resin | | BaTiO₃ | | Carbon black particles | | |
| Developer | Type | Type | Part | Part | Diameter [nm] | Type | Part | Diameter [nm] |
| A-8 | C-3 | KR-255 | 100 | 5 | 102 | EC300J | 8 | 39.5 |
| A-9 | C-4 | KR-255 | 100 | 30 | 304 | EC300J | 8 | 39.5 |
| A-10 | C-5 | KR-255 | 100 | 45 | 495 | EC300J | 8 | 39.5 |
| A-11 | C-6 | KR-255 | 100 | 45 | 495 | EC300J | 8 | 39.5 |
| A-12 | C-7 | KR-255 | 100 | 5 | 102 | EC300J | 8 | 39.5 |
| A-13 | C-8 | KR-255 | 100 | 30 | 304 | EC300J | 8 | 39.5 |
| A-14 | C-9 | KR-255 | 100 | 30 | 495 | EC300J | 8 | 39.5 |
| A-15 | C-10 | KR-255 | 100 | 45 | 102 | EC300J | 8 | 39.5 |
| A-16 | C-11 | KR-255 | 100 | 5 | 304 | EC300J | 8 | 39.5 |
| A-17 | C-12 | KR-255 | 100 | 30 | 102 | EC300J | 8 | 39.5 |
| A-18 | C-13 | KR-255 | 100 | 45 | 304 | EC300J | 8 | 39.5 |
| A-19 | C-14 | KR-255 | 100 | 5 | 495 | EC300J | 8 | 39.5 |
| A-20 | C-15 | KR-255 | 100 | 45 | 304 | EC300J | 8 | 39.5 |
| A-21 | C-16 | KR-255 | 100 | 5 | 495 | EC300J | 8 | 39.5 |
| A-22 | C-17 | KR-255 | 100 | 30 | 102 | EC300J | 8 | 39.5 |
| A-23 | C-18 | KR-255 | 100 | 5 | 304 | EC300J | 8 | 39.5 |
| A-24 | C-19 | KR-255 | 100 | 30 | 495 | EC300J | 8 | 39.5 |
| A-25 | C-20 | KR-255 | 100 | 45 | 102 | EC300J | 8 | 39.5 |
| A-26 | C-6 | KR-255 | 100 | 45 | 495 | EC300J | 8 | 39.5 |
| A-27 | C-9 | KR-255 | 100 | 30 | 495 | EC300J | 8 | 39.5 |
| A-28 | C-21 | KR-255 | 100 | 20 | 83 | EC300J | 8 | 39.5 |
| A-29 | C-22 | KR-255 | 100 | 20 | 588 | EC300J | 8 | 39.5 |
| A-30 | C-23 | KR-301 | 100 | 20 | 304 | EC300J | 8 | 39.5 |
| A-31 | C-24 | ES-1001N | 100 | 20 | 304 | EC300J | 8 | 39.5 |
| A-32 | C-25 | KR-255 | 100 | 20 | 304 | MA100 | 8 | 24.0 |

### [Evaluation 2]

Image density, fogging, and fixability were evaluated for each of the developers (A-8) to (A-32) in the same manner as for the developers (A-1) to (A-7). Evaluation results are shown below in Tables 13 and 14.

TABLE 13

| | | Inage density | | | | Fogging | | | |
|---|---|---|---|---|---|---|---|---|---|
| | Developer | ID₁ₖ | Rate | ID₁₀₀ₖ | Rate | FD₁ₖ | Rate | FD₁₀₀ₖ | Rate |
| Example 5 | A-8 | 1.31 | A | 1.24 | B | 0.003 | A | 0.014 | B |
| Example 6 | A-9 | 1.32 | A | 1.33 | A | 0.005 | A | 0.007 | A |
| Example 7 | A-10 | 1.34 | A | 1.35 | A | 0.006 | A | 0.008 | A |
| Example 8 | A-11 | 1.30 | A | 1.30 | A | 0.004 | A | 0.006 | A |
| Example 9 | A-12 | 1.31 | A | 1.33 | A | 0.004 | A | 0.007 | A |
| Example 10 | A-13 | 1.32 | A | 1.21 | B | 0.007 | A | 0.013 | B |
| Example 11 | A-14 | 1.34 | A | 1.15 | B | 0.005 | A | 0.015 | B |
| Example 12 | A-15 | 1.30 | A | 1.31 | A | 0.004 | A | 0.006 | A |
| Example 13 | A-16 | 1.33 | A | 1.23 | B | 0.012 | B | 0.015 | B |
| Example 14 | A-17 | 1.32 | A | 1.18 | B | 0.006 | A | 0.017 | B |
| Example 15 | A-18 | 1.31 | A | 1.17 | B | 0.004 | A | 0.011 | B |
| Example 16 | A-19 | 1.32 | A | 1.33 | A | 0.008 | A | 0.008 | A |
| Example 17 | A-20 | 1.34 | A | 1.31 | A | 0.004 | A | 0.005 | A |
| Example 18 | A-21 | 1.34 | A | 1.20 | B | 0.011 | B | 0.012 | B |
| Example 19 | A-22 | 1.32 | A | 1.31 | A | 0.008 | A | 0.009 | A |
| Example 20 | A-23 | 1.34 | A | 1.33 | A | 0.007 | A | 0.009 | A |
| Example 21 | A-24 | 1.34 | A | 1.18 | B | 0.012 | B | 0.015 | B |
| Example 22 | A-25 | 1.33 | A | 1.22 | B | 0.014 | B | 0.015 | B |
| Comparative Example 4 | A-26 | 1.21 | B | 0.95 | C | 0.021 | C | 0.022 | C |
| Comparative Example 5 | A-27 | 1.23 | B | 0.89 | C | 0.003 | A | 0.02 | C |
| Comparative Example 6 | A-28 | 1.33 | A | 0.92 | C | 0.004 | A | 0.023 | C |
| Comparative Example 7 | A-29 | 1.33 | A | 1.32 | A | 0.002 | A | 0.022 | C |
| Example 23 | A-30 | 1.35 | A | 1.30 | A | 0.005 | A | 0.007 | A |
| Example 24 | A-31 | 1.31 | A | 1.32 | A | 0.004 | A | 0.007 | A |
| Example 25 | A-32 | 1.33 | A | 1.35 | A | 0.005 | A | 0.005 | A |

TABLE 14

| | | Fixability | | |
|---|---|---|---|---|
| | | Evaluation | | Total |
| | Developer | value | Rate | evaluation |
| Example 5 | A-8 | 91% | A | B |
| Example 6 | A-9 | 93% | A | A |
| Example 7 | A-10 | 92% | A | A |
| Example 8 | A-11 | 93% | A | A |
| Example 9 | A-12 | 93% | A | A |
| Example 10 | A-13 | 91% | A | B |
| Example 11 | A-14 | 92% | A | B |
| Example 12 | A-15 | 92% | A | A |
| Example 13 | A-16 | 90% | A | B |
| Example 14 | A-17 | 79% | C | B |
| Example 15 | A-18 | 77% | C | B |
| Example 16 | A-19 | 76% | C | B |
| Example 17 | A-20 | 78% | C | B |
| Example 18 | A-21 | 79% | C | B |
| Example 19 | A-22 | 90% | A | A |
| Example 20 | A-23 | 91% | A | A |
| Example 21 | A-24 | 93% | A | B |
| Example 22 | A-25 | 93% | A | B |
| Comparative Example 4 | A-26 | 95% | A | C |
| Comparative Example 5 | A-27 | 94% | A | C |
| Comparative Example 6 | A-28 | 93% | A | C |
| Comparative Example 7 | A-29 | 93% | A | C |
| Example 23 | A-30 | 92% | A | A |
| Example 24 | A-31 | 93% | A | A |
| Example 25 | A-32 | 92% | A | A |

As shown in Tables 10 to 12, the developers (A-8) to (A-25) and (A-30) to (A-32) of Examples 5 to 25 each had Features X. As a result, each of the developers (A-8) to (A-25) and (A-30) to (A-32) formed images with desired image density and inhibited occurrence of fogging.

By contrast, the developer (A-26) of Comparative Example 4 included spacer particles with a number average primary particle diameter of greater than 150 nm. It is thought that contact between the toner particles and the carrier particles is inhibited by the spacer particles with a number average primary particle diameter of greater than 150 nm. As a result, the developer (A-26) caused fogging after the consecutive printing of 1000 sheets of the paper. Furthermore, the developer (A-26) formed images with insufficient image density and caused fogging after the consecutive printing of 100,000 sheets of the paper.

The developer (A-27) of Comparative Example 5 contained spacer particles and strontium titanate particles, both of the same diameter. It is thought that the spacer particles do not exhibit sufficient function of the spacer particles when the spacer particles and the strontium titanate particles have the same diameter. As a result, the developer (A-27) formed images with insufficient image density and caused fogging after the consecutive printing of 100,000 sheets of the paper.

The developer (A-28) of Comparative Example 6 contained barium titanate particles with a number average primary particle diameter of less than 100 nm. The barium titanate particles with a number average primary particle diameter of less than 100 nm had low specific permittivity. As a result, the developer (A-28) formed images with insufficient image density and caused fogging after the consecutive printing of 100,000 sheets of the paper.

The developer (A-29) of Comparative Example 7 contained barium titanate particles with a number average primary particle diameter of greater than 500 nm. The barium titanate particles with a number average primary particle diameter of 500 nm easily dissociate from the coat layers. As a result, the developer (A-29) caused fogging after the consecutive printing of 100,000 sheets of the paper.

According to the results in the developers (A-8) to (A-32), it is considered preferable to meet the following conditions in addition to having Features X.

Volume median diameter of carrier cores: at least 15.0 μm and no greater than 65.0 μm

Mass ratio of coat layers to carrier cores: at least 0.5% by mass and no greater than 5.0% by mass

Amount of barium titanate particles contained: at least 3 parts by mass and no greater than 47 parts by mass relative to 100 parts by mass of coating resin

Amount of strontium titanate particles contained: at least 0.02 parts by mass and no greater than 0.06 parts by mass relative to 100 parts by mass of carrier mother particles
Distance L: at least −15 nm and no greater than 95 nm

### <Study 3>

Further study was carried out on the coverage ratio of the spacer particles in the toner particles next.

### [Developer Preparation]

Developers (A-33) to (A-52) (toner density: 8% by mass) were prepared according to the same method as that for preparing the developers (A-1) to (A-7) in all aspects other than the following changes. In the preparation of the developers (A-33) to (A-52), the type and amount of the spacer particles in the toner particles were changed as shown below in Table 15. In the preparation of the developers (A-33) to (A-52), the aforementioned carrier (C-2) was used as the carrier. Details of the carrier (C-2), which have been previously described above, are omitted from Table 15.

Note that respective corresponding replenishment developers (toner density: 90% by mass) were also prepared separately for the developers (A-33) to (A-52). Sets of the developers (A-33) to (A-52) each being an initial developer and the respective corresponding replenishment developers were used in evaluation described below.

TABLE 15

| | Toner | | | | | | | | | |
|---|---|---|---|---|---|---|---|---|---|---|
| | | | External additive particles | | | | | | | |
| | | | | SiO₂ | | Spacer particles | | | | |
| | | Mother | | | Diam- | | | Coverage | Diam- | |
| | | particles | Al₂O₃ | | eter | | | ratio [% | eter | Distance |
| Developer | Type | Part | Part | Part | [nm] | Type | Part | by area] | [nm] | L [nm] |
| A-33 | T-26 | 100 | 0.75 | 1 | 20 | Resin (C) | 0.08 | 1.7 | 80 | 30 |
| A-34 | T-27 | 100 | 0.75 | 1 | 20 | Resin (C) | 0.1 | 2.1 | 80 | 30 |
| A-35 | T-28 | 100 | 0.75 | 1 | 20 | Resin (C) | 1.0 | 21.3 | 80 | 30 |
| A-36 | T-29 | 100 | 0.75 | 1 | 20 | Resin (C) | 1.8 | 38.3 | 80 | 30 |
| A-37 | T-30 | 100 | 0.75 | 1 | 20 | Resin (C) | 2.0 | 42.5 | 80 | 30 |
| A-38 | T-31 | 100 | 0.75 | 1 | 20 | Resin (NC) | 0.08 | 1.7 | 80 | 30 |
| A-39 | T-32 | 100 | 0.75 | 1 | 20 | Resin (NC) | 0.1 | 2.1 | 80 | 30 |
| A-40 | T-33 | 100 | 0.75 | 1 | 20 | Resin (NC) | 1.0 | 21.3 | 80 | 30 |
| A-41 | T-34 | 100 | 0.75 | 1 | 20 | Resin (NC) | 1.8 | 38.3 | 80 | 30 |
| A-42 | T-35 | 100 | 0.75 | 1 | 20 | Resin (NC) | 2.0 | 42.5 | 80 | 30 |
| A-43 | T-36 | 100 | 0.75 | 1 | 20 | SiO₂ | 0.1 | 1.3 | 60 | 10 |
| A-44 | T-37 | 100 | 0.75 | 1 | 20 | SiO₂ | 0.2 | 2.6 | 60 | 10 |
| A-45 | T-38 | 100 | 0.75 | 1 | 20 | SiO₂ | 2.0 | 25.8 | 60 | 10 |
| A-46 | T-39 | 100 | 0.75 | 1 | 20 | SiO₂ | 3.0 | 38.6 | 60 | 10 |
| A-47 | T-40 | 100 | 0.75 | 1 | 20 | SiO₂ | 3.5 | 45.1 | 60 | 10 |
| A-48 | T-41 | 100 | 0.75 | 1 | 20 | Composite C | 0.1 | 1.9 | 76 | 26 |
| A-49 | T-42 | 100 | 0.75 | 1 | 20 | Composite C | 0.12 | 2.2 | 76 | 26 |
| A-50 | T-43 | 100 | 0.75 | 1 | 20 | Composite C | 1.0 | 18.6 | 76 | 26 |
| A-51 | T-44 | 100 | 0.75 | 1 | 20 | Composite C | 2.0 | 37.8 | 76 | 26 |
| A-52 | T-45 | 100 | 0.75 | 1 | 20 | Composite C | 2.2 | 41.0 | 76 | 26 |

### [Evaluation 3]

Image density, fogging, and fixability were evaluated for each of the developers (A-33) to (A-52) in the same manner as for the developers (A-1) to (A-7). Evaluation results are shown below in Tables 16 and 17.

TABLE 16

| | | Image density | | | | Fogging | | | |
|---|---|---|---|---|---|---|---|---|---|
| | Developer | ID₁ₖ | Rate | ID₁₀₀ₖ | Rate | FD₁ₖ | Rate | FD₁₀₀ₖ | Rate |
| Comparative Example 8 | A-33 | 1.32 | A | 0.98 | C | 0.006 | A | 0.024 | C |
| Example 26 | A-34 | 1.32 | A | 1.14 | B | 0.004 | A | 0.019 | B |
| Example 27 | A-35 | 1.34 | A | 1.32 | A | 0.004 | A | 0.009 | A |
| Example 28 | A-36 | 1.33 | A | 1.18 | B | 0.010 | B | 0.016 | B |
| Comparative Example 9 | A-37 | 1.25 | B | 0.95 | C | 0.021 | C | 0.022 | C |
| Comparative Example 10 | A-38 | 1.35 | A | 0.97 | C | 0.005 | A | 0.024 | C |
| Example 29 | A-39 | 1.33 | A | 1.15 | B | 0.004 | A | 0.018 | B |
| Example 30 | A-40 | 1.33 | A | 1.33 | A | 0.006 | A | 0.008 | A |
| Example 31 | A-41 | 1.32 | A | 1.10 | B | 0.011 | B | 0.017 | B |
| Comparative Example 11 | A-42 | 1.24 | B | 0.96 | C | 0.021 | C | 0.021 | C |
| Comparative Example 12 | A-43 | 1.33 | A | 0.98 | C | 0.006 | A | 0.023 | C |
| Example 32 | A-44 | 1.34 | A | 1.14 | B | 0.006 | A | 0.019 | B |
| Example 33 | A-45 | 1.33 | A | 1.33 | A | 0.008 | A | 0.008 | A |
| Example 34 | A-46 | 1.35 | A | 1.08 | B | 0.012 | B | 0.018 | B |
| Comparative Example 13 | A-47 | 1.26 | B | 0.95 | C | 0.021 | C | 0.023 | C |
| Comparative Example 14 | A-48 | 1.32 | A | 0.96 | C | 0.004 | A | 0.021 | C |
| Example 35 | A-49 | 1.31 | A | 1.18 | B | 0.006 | A | 0.016 | B |
| Example 36 | A-50 | 1.34 | A | 1.32 | A | 0.006 | A | 0.007 | A |
| Example 37 | A-51 | 1.33 | A | 1.09 | B | 0.013 | B | 0.016 | B |
| Comparative Example 15 | A-52 | 1.26 | B | 0.97 | C | 0.020 | C | 0.020 | C |

TABLE 17

| | | Fixability | | |
|---|---|---|---|---|
| | | Evaluation | | Total |
| | Developer | value | Rate | evaluation |
| Comparative Example 8 | A-33 | 93% | A | C |
| Example 26 | A-34 | 93% | A | B |
| Example 27 | A-35 | 92% | A | A |
| Example 28 | A-36 | 91% | A | B |
| Comparative Example 9 | A-37 | 90% | A | C |
| Comparative Example 10 | A-38 | 94% | A | C |
| Example 29 | A-39 | 94% | A | B |
| Example 30 | A-40 | 93% | A | A |
| Example 31 | A-41 | 92% | A | B |
| Comparative Example 11 | A-42 | 90% | A | C |
| Comparative Example 12 | A-43 | 79% | C | C |
| Example 32 | A-44 | 78% | C | B |
| Example 33 | A-45 | 76% | C | B |
| Example 34 | A-46 | 74% | C | B |
| Comparative Example 13 | A-47 | 74% | C | C |
| Comparative Example 14 | A-48 | 89% | B | C |
| Example 35 | A-49 | 87% | B | B |
| Example 36 | A-50 | 86% | B | A |
| Example 37 | A-51 | 83% | B | B |
| Comparative Example 15 | A-52 | 83% | B | C |

As shown in Table 15, the developers (A-34) to (A-36), (A-39) to (A-41), (A-44) to (A-46), and (A-49) to (A-51) of examples 26 to 37 each had Features X. As a result, any of these developers formed images with desired image density and inhibited occurrence of fogging.

By contrast, the developer (A-33) of Comparative Example 8, the developer (A-38) of Comparative Example 10, the developer (A-43) of Comparative Example 12, and the developer (A-48) of Comparative Example 14 each had a coverage ratio of the spacer particles in the toner particles of less than 2.0% by area. These developers, which were short of the spacer particles, formed images with insufficient image density and caused fogging after the consecutive printing on 100,000 sheets of the paper.

By contrast, the developer (A-37) of Comparative Example 9, the developer (A-42) of Comparative Example 11, the developer (A-47) of Comparative Example 13, and the developer (A-52) of Comparative Example 15 each had a coverage ratio of the spacer particles in the toner particles of greater than 40.0% by area. It is thought in each of these developers that contact between the silica particles of the toner and the strontium titanate particles of the carrier was inhibited by the spacer particles. As a result, each of these developers caused fogging after the consecutive printing on 1000 sheets of the paper. Furthermore, these developers formed images with insufficient image density and caused fogging after the consecutive printing of 100,000 sheets of the paper.

What is claimed is:

1. A developer comprising:
a toner containing toner particles; and
a carrier containing carrier particles, wherein
the toner particles each include a toner mother particle and external additive particles attached to a surface of the toner mother particle,
the external additive particles include first silica particles and spacer particles,
the first silica particles have a number average primary particle diameter of at least 10 nm and no greater than 30 nm,
the spacer particles have a number average primary particle diameter of at least 32 nm and no greater than 145 nm,
the spacer particles in the toner particles have a coverage ratio of at least 2.0% by area and no greater than 40.0% by area,
the carrier particles each include a carrier mother particle and strontium titanate particles attached to a surface of the carrier mother particle,
the carrier mother particles each include a carrier core and a coat layer covering a surface of the carrier core,
the coat layers contain a coating resin and barium titanate particles,
the coating resin includes silicone resin,
the barium titanate particles have a number average primary particle diameter of at least 100 nm and no greater than 500 nm,
the strontium titanate particles have a number average primary particle diameter of at least 15 nm and no greater than 85 nm, and
the number average primary particle diameter of the spacer particles is greater than the number average primary particle diameter of the strontium titanate particles.

2. The developer according to claim 1, wherein
the spacer particles have chargeability with a same polarity as that of the toner particles.

3. The developer according to claim 1, wherein
the spacer particles include resin particles, and
the resin particles have a number average primary particle diameter of at least 32 nm and no greater than 125 nm.

4. The developer according to claim 1, wherein
the spacer particles include second silica particles, and
the second silica particles have a number average primary particle diameter of at least 32 nm and no greater than 145 nm.

5. The developer according to claim 1, wherein
the spacer particles include composite particles,
the composite particles include resin particles and third silica particles attached to surfaces of the resin particles,
the resin particles have a number average primary particle diameter of at least 32 nm and no greater than 110 nm, and
the third silica particles have a number average primary particle diameter of at least 10 nm and no greater than 30 nm.

6. The developer according to claim 5, wherein
the third silica particles have a same composition and a same number average primary particle diameter as the first silica particles.

7. The developer according to claim 1, wherein
a distance L calculated using an equation below is at least −15 nm and no greater than 95 nm:
distance L=(the Number Average Primary Particle Diameter of the Spacer Particles)−((the number average primary particle diameter of the strontium titanate particles)+(the number average primary particle diameter of the first silica particles)).

8. An image forming apparatus comprising:
a developer; and
a development device that develops an electrostatic latent image with the developer, wherein
the developer includes an initial developer,
the development device includes an accommodation section that accommodates the initial developer, and
the initial developer is the developer according to claim 1.

9. The image forming apparatus according to claim 8, wherein
the developer further includes a replenishment developer, and
the development device further includes a replenishment section that replenishes the accommodation section with the replenishment developer.
